(19) United States
(12) Patent Application Publication
(10) Pub. No.: US 2008/0215470 A1
(43) Pub. Date: Sep. 4, 2008

(54) Methods and apparatus for use in association with payment card accounts

(76) Inventors: Sabyaschi Sengupta, Valhalla, NY (US); Fuchu Shen, New Rochelle, NY (US)

Correspondence Address: BUCKLEY, MASCHOFF & TALWALKAR LLC, 50 LOCUST AVENUE, NEW CANAAN, CT, 06840, US

(21) Appl. No.: 11/713,223

(22) Filed: Mar. 2, 2007

(51) Int. Cl. G06Q 40/00

(52) U.S. Cl. 705/35

(57) ABSTRACT

In one aspect, a method includes: receiving data indicative of one or more characteristics of a customer having an existing or prospective relationship with a retail business; providing data indicative of a plurality of possible payment card accounts that are available from a financial institution for customers of the retail business, each of the plurality of possible payment card accounts having at least one characteristic; determining a plurality of estimates, each of the plurality of estimates being associated with a respective one of the plurality of possible payment card accounts and indicative of a financial metric that would be realized by the retail business if the customer had a payment card account having the at least one characteristic of the associated one of the lo plurality of possible payment card accounts; and selecting one of the plurality of possible payment card accounts based at least in part on the estimate associated with the possible payment card account and on selection criteria that includes at least one criteria related to a financial metric of the retail business.

### FIELD OF THE INVENTION

The present disclosure relates to methods and apparatus for use in association with payment cards accounts.

### BACKGROUND OF THE INVENTION

Many retail businesses offer payment cards to customers in order to encourage repeat business. For example, some retailers, such as SAM'S CLUB, WALMART, GAP INC., and J.C. PENNY COMPANY, INC. offer “private label” or store credit cards to their customers. These private label or store credit cards may only be used to make purchases at the retailer who offers the card (e.g., a WALMART private label card can only be used for purchases at WALMART). Many retailers offer co-branded credit cards to their customers. A co-branded credit card is a general purpose bank card issued under a payment association such as VISA or MASTERCARD and may be used to make purchases anywhere the payment association card is accepted. The card may be used to enjoy enhanced benefits at the co-brand retailer, and generally is co-branded with the payment association brand and the retailers brand.

Recently, a new type of payment card has been introduced by the assignee of the present invention. This new type of card is referred to herein as a “dual card”. A dual card allows a customer to enjoy the benefits of a private-label card and a general purpose bank card—it can be used as a private label card when used for purchases at the sponsoring retailer, and it can be used as a general purpose bank card for purchases at other retailers.

Retailers market and solicit applications for specific payment card products through in-store and other marketing. For example, a retailer who operates a private label credit card program may market the product to existing and prospective customers. To obtain a payment card associated with the retailer, the retailer may require that the customer fill out an application, for example, at a retail outlet or on a Website for the business. The application may then be forwarded to the financial institution that administers and/or underwrites the private label credit card program. Typically, retailers market a single type of product (e.g., a private label, co-brand, or dual card product) to customers, and each customer's application is for a specific product.

Thereafter, the financial institution determines whether to approve the customer for a payment card account. In determining whether to approve the account, the financial institution may consider the likelihood that the account, if approved, would result in a profit or a loss for the financial institution.

If the application is approved, the financial institution thereafter determines a 10 credit limit and/or the interest rate for the account. In doing so, the financial institution may consider the likelihood that a particular credit limit and/or interest rate would result in a profit or loss for the financial institution. The decision by the financial institution may be forwarded to the store employee who may in turn inform the customer. Depending upon the situation, the processing of the application may be completed in just a few minutes or less.

From time to time, the financial institution may decide to change the credit limit and/or interest rate on the account, within the limits of any agreements with the customer. In doing so, the financial institution may again consider the likelihood that a particular credit limit and/or interest rate would result in a profit or loss for the financial institution. For example, if the account is in good standing and profitable, the financial institution may decide to increase the credit limit of the account in the hope of increasing such profit

Various methods and apparatus are currently used in association with payment cards. Notwithstanding the availability of such methods and apparatus, further methods and apparatus for use in association with payment cards are desired.

### BRIEF SUMMARY OF THE INVENTION

Methods, apparatus and/or computer program products presented herein may be used in association with payment card accounts.

In accordance with a first aspect, a method comprises receiving data indicative of one or more characteristics of a customer having an existing or prospective relationship with a retail business; providing data indicative of a plurality of possible payment card accounts that are available from a financial institution for customers of the retail business, each of the plurality of possible payment card accounts having at least one characteristic; determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and selecting one of the plurality of possible payment card accounts based at least in part on the estimate associated with the possible payment card account and on selection criteria that includes at least one criteria related to a financial metric of the retail business.

In accordance with another aspect, an apparatus comprises: a processing system to (1) receive data indicative of one or more characteristics of a customer having an existing or prospective relationship with a retail business, (2) provide data indicative of a plurality of possible payment card accounts that are available from a financial institution for customers of the retail business, each of the plurality of possible payment card accounts having at least one characteristic, (3) determine a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts, and (4) select one of the plurality of possible payment card accounts based at least in part on the estimate associated with the possible payment card account and on selection criteria that includes at least one criteria related to a financial metric of the retail business.

In accordance with another aspect, an apparatus comprises: means for receiving data indicative of one or more characteristics of a customer having an existing or prospective relationship with a retail business; means for providing data indicative of a plurality of possible payment card accounts that are available from a financial institution for customers of the retail business, each of the plurality of possible payment card accounts having at least one characteristic; means for determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and means for selecting one of the plurality of possible payment card accounts based at least in part on the estimate associated with the possible payment card account and on selection criteria that includes at least one criteria related to a financial metric of the retail business.

In accordance with another aspect, a computer program product comprises: a storage medium having stored thereon instructions that if executed by a machine, result in the following: receiving data indicative of one or more characteristics of a customer having an existing or prospective relationship with a retail business; providing data indicative of a plurality of possible payment card accounts that are available from a financial institution for customers of the retail business, each of the plurality of possible payment card accounts having at least one characteristic; determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and selecting one of the plurality of possible payment card accounts based at least in part on the estimate associated with the possible payment card account and on selection criteria that includes at least one criteria related to a financial metric of the retail business.

In accordance with another aspect, a storage medium has stored thereon instructions that if executed by a machine, result in the following: receiving data indicative of one or more characteristics of a customer having an existing or prospective relationship with a retail business; providing data indicative of a plurality of possible payment card accounts that are available from a financial institution for customers of the retail business, each of the plurality of possible payment card accounts having at least one characteristic; determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and selecting one of the plurality of possible payment card accounts based at least in part on the estimate associated with the possible payment card account and on selection criteria that includes at least one criteria related to a financial metric of the retail business.

Although various features, attributes and/or advantages may be described herein and/or may be apparent in light of the description herein, it should be understood that unless stated otherwise, such features, attributes and/or advantages are not required and need not be present in all aspects and/or embodiments.

### BRIEF DESCRIPTION OF THE DRAWINGS

The accompanying drawings, which are incorporated in and form a part of the specification, illustrate some embodiments of the present disclosure, and together with the descriptions serve to explain some of the principles of the disclosure.

FIG. 1 is a flowchart of a process in accordance with some embodiments;

FIG. 2 is a block diagram representation of a processing system and a customer in accordance with some embodiments;

FIG. 3 is a functional block diagram of one embodiment of a portion of the processing system of FIG. 2;

FIG. 4 is a table of possible payment card accounts and estimates of financial metrics, in accordance with some embodiments, in accordance with some embodiments;

FIG. 5 is a block diagram of one embodiment of an estimator of the portion of the processing system of FIG. 3;

FIG. 6 is a block diagram of one embodiment of a model of the estimator of FIG. 5;

FIG. 7 is a graphical representation of one embodiment of the model of the estimator of FIG. 5; and

FIG. 8 is a flowchart of a process in accordance with some embodiments;

FIG. 9A is a table of possible payment card accounts and estimates of financial metrics, in accordance with some embodiments, in accordance with some embodiments;

FIG. 9B is a table of possible payment card accounts and estimates of financial metrics, in accordance with some embodiments, in accordance with some embodiments;

FIG. 9C is a table of possible payment card accounts and estimates of financial metrics, in accordance with some embodiments, in accordance with some embodiments;

FIG. 10 is a report, in accordance with some embodiments;

FIG. 11 is a report, in accordance with some embodiments; and

FIG. 12 is a block diagram of a one embodiment of the processing system of FIG. 2.

### DETAILED DESCRIPTION

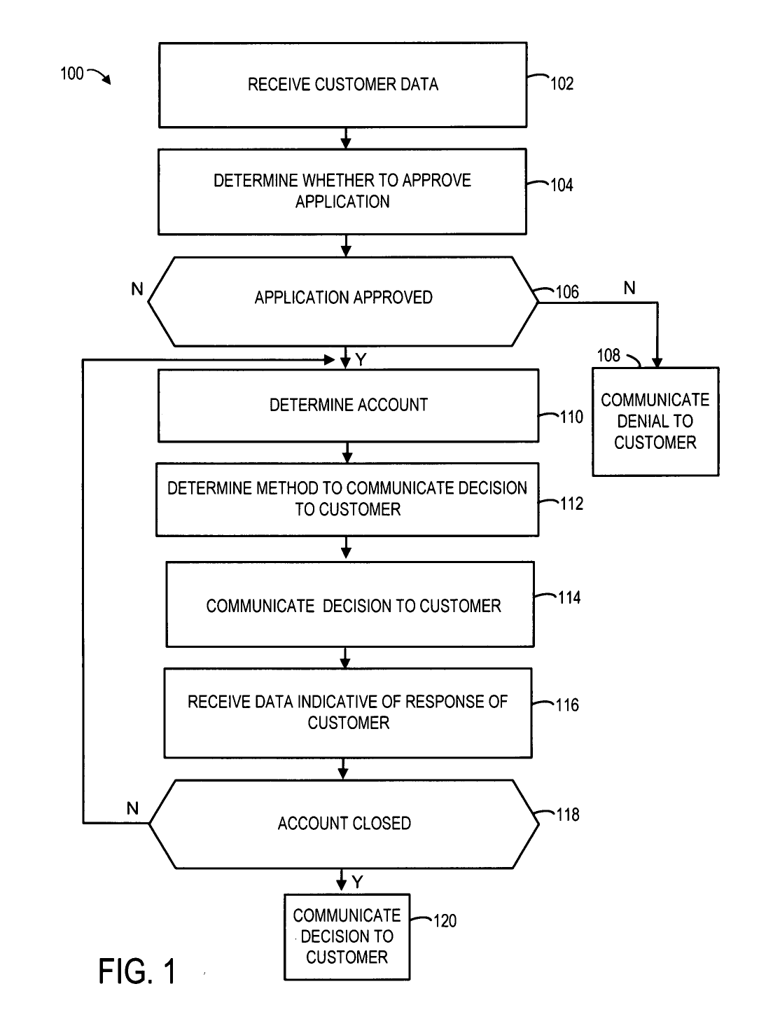

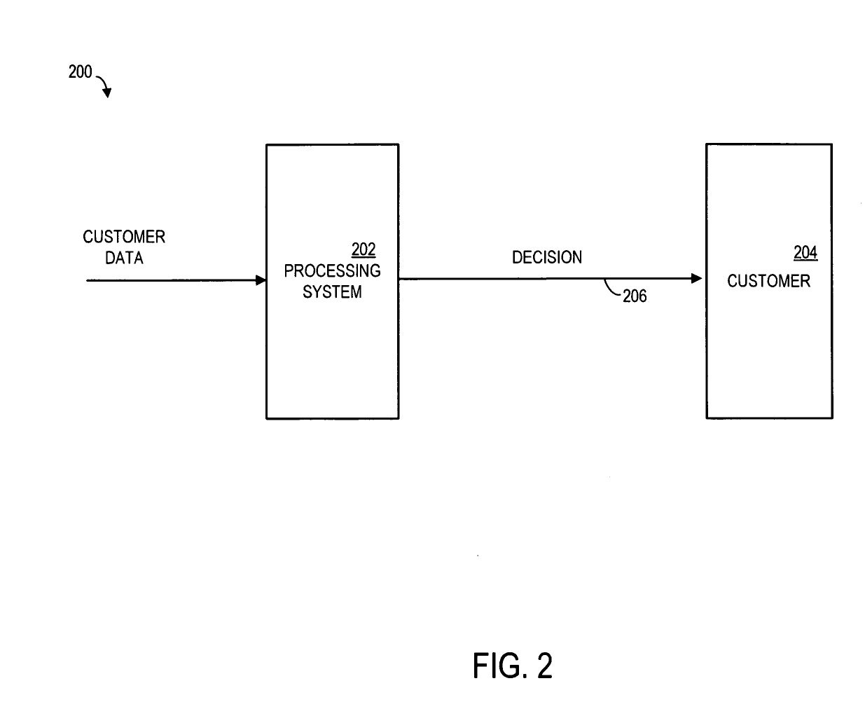

FIG. 1 is a flow chart of a process 100 according to some embodiments. The process 100 is not limited to the order shown in the flow chart. Rather, embodiments of the process 100 may be performed in any order that is practicable. For that matter, unless stated otherwise, any process disclosed herein may be performed in any order that is practicable. Unless stated otherwise, the process 100 may be performed by in any manner. In that regard, in some embodiments, one or more portions of one or more process may be performed by a processing system. As further described hereinafter, in some embodiments, a processing system may comprise hardware, software (including microcode), firmware, or any combination thereof. In some embodiments, one or more portions of one or more processes disclosed herein may be performed by a processing system such as the processing system in FIG. 2.

The process, or one or more portions thereof, may be used in association with private label credit cards accounts associated with a retail business, co-brand credit card accounts associated with a retail business, dual cards associated with a retail business, and/or any other type(s) of payment card accounts. In some embodiments, other types of payment products may also be used in association with embodiments of the present invention such as, for example, stored value cards, debit cards, or the like. Those skilled in the art will recognize that the payment cards issued pursuant to some embodiments may be any of a number of different types of physical embodiments, including, for example, magnetic stripe cards, radio frequency identification (“RFID”) cards, contact or contactless smart cards, virtual credit or debit cards, etc.

Referring to FIG. 1, at 102, the process may include receiving data indicative of one or more characteristics of a customer, sometimes referred to hereinafter as customer data. As used herein, a customer may comprise any type of customer, for example, but not limited to, a previous customer, a current customer, a prospective customer and/or a future customer.

The customer data may include any type of data indicative of one or more characteristics of the customer. In that regard, in some embodiments, the customer data may include personal information for example, name, address, date of birth, social security number, income and/or expenses of the customer and/or a credit history of the customer, for example, from one or more credit bureaus. In some embodiments, the customer data may include purchasing data and/or payment data for the consumer.

The customer data may be provided by any suitable source(s) of customer data. In some embodiments, one or more portions of the customer data may be supplied, directly and/or indirectly, by the customer. For example, the customer may fill out an application at a retail outlet or online at a website for the retail business. The application may request personal information for example, the customer's name, address, social security number, income and/or expenses, etc. If the customer is applying in person, the customer may supply the one or more portions of the customer data on a written application. After filling out the application, the customer may give it to an employee of the retail business. The employee may thereafter enter the customer's personal information into a computer system, which may forward the personal information to a finance company, a bank and/or any other type of financial institution that may administer and/or underwrites a private label credit card program associated with the retail business. As used herein a “financial institution” may comprise, but is not limited to, a finance company and/or a bank.

If the customer is applying online, the customer may supply one or more portions of the customer data through a user interface. In some embodiments, a user interface may include a personal computer that executes a browser program, receives signals from one or more input devices, for example, a mouse and/or keyboard, supplies signals to one or more output devices, for example, a display, and forwards the personal information to the financial institution.

In some embodiments, one or more portions of the customer data may be supplied by the financial institution. For example, the financial institution may have one or more databases that include historical data indicative of purchases, payments and/or delinquencies for the customer, sometimes referred to herein as customer behavior data, in regard to one or more other accounts of the customer that are underwritten and/or managed by the financial institution. In that regard, the one or more other accounts underwritten and/or managed by the financial institution may include one or more other payment card accounts for the customer.

In some embodiments, one or more portions of the customer data may be supplied by one or more databases. For example, in some embodiments, a credit history of the customer may be obtained from one or more credit bureaus.

In some embodiments, one or more of the above types of customer data may overlap with one another. In some embodiments, one or more of the above sources of data may overlap with one another.

The customer data may have any form, for example, but not limited to, analog and/or digital (e.g., a sequence of binary values, i.e. a bit string) signal(s) in serial and/or in parallel form.

At 104, the process may further include determining whether to approve the application for a private label credit card account. In some embodiments, the determination may be based at least in part on (1) customer data (e.g., income, expense, credit history), (2) historical data, (3) one or more metrics related to profit or loss for the financial institution and/or (4) one or more metrics related to sales of the retail business.

Historical data may include but is not limited to historical data for one or more current and/or previous accounts, which may include, but is not limited to (1) customer data of one or more customers having the one or more current and/or previous accounts, (2) purchasing,data, payment data, delinquency data and/or other customer behavior data in regard to the one or more current and/or previous accounts and/or (3) data indicative of the account type(s), credit limit(s) and/or interest rate(s) of the one or more current and/or previous accounts. The one or more current and/or previous accounts may include, but are not limited to, one or more other private label credit card accounts, dual card accounts, co-brand credit card accounts and/or bank payment card accounts, which may or may not be underwritten and/or managed by the financial institution.

The one or more metrics related to profit or loss for the financial institution may include an estimate of profit and/or loss that would be realized by the financial institution as a result of giving the customer an account. The one or more metrics related to sales of the retail business may include an estimate of sales that would be realized by the retail business as a result of giving the customer an account. In some embodiments, one or more of the one or more metrics may be based at least in part on historical data. Some embodiments that base the determination, at least in part, on one or more metrics related to sales of the retail business may result in increased sales for the retail business.

In some embodiments, one or more of the factors listed above may overlap with one another and/or may be based at least in part on one another. For example, as described herein, customer data and historical data may each include customer purchasing data, customer payment data and/or other customer historical data. Moreover, as described herein, in some embodiments, one or more of the one or more metrics may be based at least in part on customer data and/or historical data.

In some embodiments, the financial institution may not approve the account unless there is a likelihood that the account, if approved, would result in a profit for the financial institution. In some other embodiments, the financial institution may approve the account even if there is a likelihood that the account would result in no profit and/or a loss for the financial institution. Note that it may be in the interest of the retail business to have the account approved even if there is a likelihood that the account would result in no profit and/or a loss for the financial institution.

At 106, the process may include determining whether the application is approved, and if not, at 108, the denial may be communicated to the customer. If the application is approved, then at 110, the process may include determining a credit limit and/or interest rate for the account. In some embodiments, various credit limits and/or interest rates may be considered. In some embodiments, the determination may be based at least in part on one or more of the factors listed above, i.e., (1) customer data (e.g., income, expense, credit history), (2) historical data, (3) one or more metrics related to profit or loss for the financial institution and/or (4) one or more metrics related to sales of the retail business.

The one or more metrics related to profit or loss for the financial institution may include an estimate of profit and/or loss that would be realized by the financial institution as a result of giving the customer an account having a particular credit limit and/or interest rate. The one or more metrics related to sales of the retail business may include an estimate of sales that would be realized by the retail business as a result of giving the customer an account having a particular credit limit and/or interest rate. Some embodiments that base the determination, at least in part, on one or more metrics related to sales of the retail business may result in increased sales for the retail business.

In some embodiments, the determination may include selecting a credit limit and/or interest rate that maximizes profit for the financial institution. In some other embodiments, the determination may include not selecting a credit limit and/or interest rate that maximizes profit for the financial institution. In that regard, in some embodiments, the determination may include selecting a credit limit and/or interest rate that maximizes sales of the retail business. In some embodiments, the determination may include selecting a credit limit and/or interest rate that is likely to result in no profit and/or a loss for the financial institution. Note that in some embodiments, it may be in the interest of the retail business for the customer to have (1) a high credit limit and a low interest rate rather than (2) a low credit limit and a high interest rate, so as to encourage the customer to use the account to purchase merchandise from the retail business on a regular basis.

At 112, the process may further include determining a method to communicate the decision to the customer. In some embodiments, the determination may be based at least in part on one or more of the factors listed above, i.e., (1) customer data (e.g., income, expense, credit history), (2) historical data, (3) one or more metrics related to profit or loss for the financial institution and/or (4) one or more metrics related to sales of the retail business.

In some embodiments, one or more methods of communication may be more effective in one or more regards than one or more other methods of communication. In that regard, in some embodiments, the process may include selecting a method to which the customer is likely to respond most favorably.

In some embodiments, the process includes selecting from a group of methods that may include, but need not be limited to, one or more of the following:

communicating the decision in person, communicating the decision via direct mail, communicating the decision via email, communicating the decision via telephone, communicating the decision via a telemarketer, communicating the decision via a cellular telephone, communicating the decision via voice mail, communicating the decision via the Internet, communicating the decision via a statement of account activity (e.g., a statement message and/or an added statement page), communicating the decision via a portable data assistant (PDA), communicating the decision via a message service (e.g., a short message service (SMS/MM) available on cellular telephones) and/or a combination thereof.

At 114, the process may further include communicating the decision to the customer using the method determined at 112. If the customer has applied in person at a retail outlet, the decision may be forwarded to the store employee who may in turn inform the customer. If the customer has applied online through a user interface, the decision may be forwarded to the customer through the user interface, by direct mail and/or by telephone. In some embodiments, a decision may be communicated to the customer within a few minutes of submitting an application.

At 116, the process may further include receiving customer data indicative of one or more behavior characteristics of the customer, sometimes referred to hereinafter as customer behavior data. In some embodiments, the customer behavior data may include the purchasing and/or payment behavior of the customer in regard to the account. The purchasing behavior of the customer may include the number and/or type of purchases made by the customer using the account and/or the dollar amount of such purchases. The payment behavior of the customer may include the payment history and/or balance history of the customer in regard to the account and/or one or more other accounts. In some embodiments, the customer behavior data may include a credit history of the customer received from one or more credit bureaus.

The customer behavior data may be provided by any suitable source(s) of customer data. In some embodiments, one or more portions of the customer behavior data may be supplied by one or more databases. The customer behavior data may have any form, for example, but not limited to, analog and/or digital (e.g., a sequence of binary values, i.e. a bit string) signal(s) in serial and/or in parallel form.

Note that in some embodiments, a customer's behavior may depend, at least in part, on one or more characteristics of the account, for example, the credit limit and/or the interest rate of the account.

At 118, the process may include determining whether the account should be closed, and if so, at 120, the decision may be communicated to the customer. In some embodiments, the determination may be based at least in part on one or more of the factors listed above, i.e., (1) customer data (e.g., income, expense, credit history, purchasing history, payment history), (2) historical data, (3) one or more metrics related to profit or loss for the financial institution, (4) one or more metrics related to sales of the retail business and/or (5) any agreements with the customer, for example, a cardholder agreement.

In some embodiments, the one or more metrics related to profit or loss for the financial institution may include whether the account has resulted in a profit or a loss for the financial institution and/or an estimate of profit and/or loss that would be realized by the financial institution as a result of not closing the account. In some embodiments, the one or more metrics related to profit or loss for the financial institution may include whether an account has gone “bad” and/or an account's likelihood of going “bad”.

However, in some embodiments, the financial institution may determine not to close the account even if the account has resulted in a loss for the financial institution and/or even if there is a likelihood that the account would result in a loss for the financial institution in the future. Note that in some embodiments, it may be in the interest of the retail business to have the financial institution not close the account and for the customer to use the account to purchase merchandise from the retail business on a regular basis.

In some embodiments, it may be very rare to close an account. In that regard, in some embodiments, the financial institution may decide to close an account only after other measures have been explored and/or exhausted.

If the account is not closed, the process may return to 110 and may further include determining whether to change one or more characteristics of the account, and if so, the new characteristic or characteristics of the account. In some embodiments, various credit limits and/or interest rates may be considered. In some embodiments, the determination may be based at least in part on one or more of the factors listed above, i.e., (1) customer data (e.g., income, expense, credit history, purchasing history, payment history), (2) historical data, (3) one or more metrics related to profit or loss for the financial institution, (4) one or more metrics related to sales of the retail business and/or (5) any agreements with the customer, for example, a cardholder agreement.

In some embodiments, the one or more metrics related to profit or loss for the financial institution may include an estimate of profit and/or loss that would be realized by the financial institution as a result of giving the customer an account having a particular credit limit and/or interest rate. The one or more metrics related to sales of the retail business may include an estimate of sales that would be realized by the retail business as a result of giving the customer an account having a particular credit limit and/or interest rate.

In some embodiments, the one or more metrics related to profit or loss for the financial institution may include whether the account has resulted in a profit or a loss for the financial institution. For example, if the account is in good standing and profitable to the financial institution, the financial institution may decide to increase the credit limit of the account in the hope of increasing such profit. In some embodiments, the determination may include selecting a credit limit and/or interest rate that maximizes profit for the financial institution.

In some embodiments, determining whether to make a change to one or more characteristics of the account may be based at least in part on the customer's utilization of the account. Different customers may have different behavioral characteristics and/or different needs. In that regard, in some embodiments, some customers may need an increase in the credit limit of their account and may respond favorably thereto. Other customers may not need an increase in the credit limit of their account and thus may not respond to such an increase.

However, in some embodiments, a customer's behavior may depend, at least in part, on one or more characteristics of the account, for example, the credit limit and/or the interest rate of the account. For example, a higher credit limit for customers allow the customers to purchase more, carry higher balances and revolve higher balances. In addition, higher credit limits may also make an account more competitive and/or promote customer loyalty.

In some other embodiments, the determination may include not selecting a credit limit and/or interest rate that maximizes profit for the financial institution. In that regard, in some embodiments, the determination may include selecting a credit limit and/or interest rate that maximizes sales of the retail business. For example, in some embodiments, it may be in the interest of the retail business for the customer to have (1) a high credit limit and a low interest rate rather than (2) a low credit limit and a high interest rate, so as to encourage the customer to use the account to purchase merchandise from the retail business on a regular basis.

In some embodiments, the financial institution may select a credit limit and/or interest rate that is likely to result in no profit and/or a loss for the financial institution. As stated above, in some embodiments, the determination may be based at least in part on customer behavior. Customer behavior may include the customer's purchasing and/or payment history.

If one or more characteristics of the account are to be changed, then at 112, the process may further include determining a method to communicate the decision to the customer, and at 114, the process may further include communicating the decision to the customer using the method determined at 112 so that the customer is informed of the decision to change the credit limit and/or interest rate on the account.

It should be understood that a change in a credit limit and/or interest rate may or may not have a desired effect. For example, an increase in the credit limit of the account may or may not lead to an increase in purchases and/or profit to the financial institution. In that regard, at 116, the process may further include receiving data indicative of one or more behavior characteristics of the customer after the change.

In some embodiments, 110-116 may be repeated from time to time. In some embodiments, 110-116 may be repeated at a periodic interval. In some other embodiments, 110-116 may be repeated at non periodic intervals.

FIG. 2 is a block diagram of a system 200, according to some embodiments. Referring to FIG. 2, the system 200 includes a processing system 202. In some embodiments, the processing system 202 may be used to perform one or more portions of one or more embodiments of the process 100 (FIG. 1) and/or one or more portions of one or more embodiments of any other process disclosed herein.

In accordance with some embodiments. the processing system 202 may receive customer data. As stated above, the customer data may comprise any type of data supplied by any source or sources of data and may be in any form or forms.

In some embodiments, the customer data may comprise customer data for a customer, e.g., customer 204, applying for a payment card associated with a retail business (such as a private label credit card, a co-brand credit card and/or a dual credit card ). For simplicity, throughout the remainder of this disclosure, the various payment cards applied for (and approved and/or issued) will be referred to as either a “payment card” or a “credit card” (such as a private label credit card, a dual card credit card or a co-branded credit card). Other payment card products may also be used, such as, for example, stored value or debit card products, and the reference to credit cards is not intended to be limiting. Further, although “cards” are discussed, those skilled in the art will recognize that some embodiments may also include the issuance of “virtual” products that are issued without a physical manifestation of the card itself. In such embodiments, the processing system 202 may determine whether to approve the application, and if so, one or more characteristics (e.g., a type of credit card, a credit limit, interest rate and/or balance transfer offer) for the account. In some embodiments the processing system 202 may establish or cause the establishment of the payment card account for the customer 204.

In some embodiments, only one type of payment card account may be available. In such embodiments, the one type of payment card account may be a private label credit card account, a dual card account, a co-brand credit card account and/or any other type of payment card account. In some embodiments, more than one type of payment card account may be available. In such embodiments, such more than one type of payment card account may include a private label credit card account, a dual card account, a co-brand credit card account and/or any other type(s) of payment card account(s).

The decision regarding the account may be supplied to the customer 204 via one or more channels of communication 206. In some embodiments, the processing system may select the one or more channels of communication to be used to communicate the decision. In some embodiments, the decision may comprise an offer for a payment card account. In some embodiments, the decision may comprise a decision to establish a payment card account for the customer.

In some embodiments, the customer data may comprise customer data for a customer, e.g., customer 204, that already has a payment card account (such as a private label credit card associated with a retail business and/or dual credit card account associated with a retail business, etc.). In such embodiments, the processing system 202 may determine whether the account should be closed, and if not, whether one or more characteristics of the account should be changed. If the processing system 202 determines that one or more characteristics of the account should be changed, the processing system 202 may determine the one or more new characteristics of the payment card account. In some embodiments, the processing system 202 may change the payment card account of the customer in accordance therewith.

The decision regarding the account may be supplied to the customer 204 via one or more channels of communication 206. In some embodiments, the decision may comprise a decision to change the payment card account. As stated above, one or more methods of communication may be more effective in one or more regards than one or more other methods of communication. In some embodiments, the processing system 202 may select the one or more channels of communication to be used to communicate the decision. In some embodiments, the processing system 202 may select a method to which the customer 204 is likely to respond most favorably. In some embodiments, the one or more channels of communication 206 may include, but is not be limited to, one or more methods of communication disclosed herein.

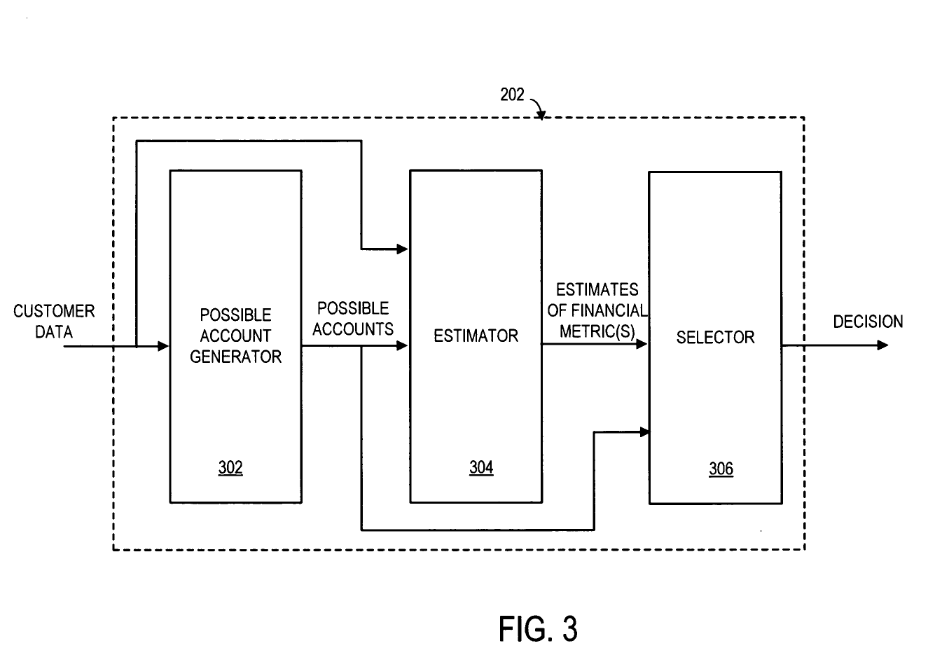

FIG. 3 is a functional block diagram of a portion of the processing system 202 in accordance with some embodiments. Referring to FIG. 3, in accordance with some embodiments, the processing system 202 may include a possible account generator 302, an estimator 304 and a selector 306.

The possible account generator 302 may receive the customer data and may supply data indicative of a plurality of possible payment card accounts, sometimes referred to hereinafter as possible payment card account data. The plurality of possible payment card accounts may include various combinations of card types, credit limits, interest rates and/or an offer of a balance transfer that may be available from the financial institution. In some embodiments, each possible payment card account includes a type of payment card, a credit limit, an interest rate and/or an offer of a balance transfer.

In some embodiments, only one type of payment card account may be available. In such embodiments, the one type of payment card account may be a private label credit card account, a dual card account, a co-brand credit card account and/or any other type of payment card account. In some embodiments, more than one type of payment card account may be available. In such embodiments, such more than one type of payment card account may include a private label credit card account, a dual card account, a co-brand credit card account and/or any other type(s) of payment card account(s).

In one illustrative embodiment, two different types of payment cards, six different credit limits and seven different interest rates may be available. The two different types of payment cards may include a private label credit card and a dual card and/or co-brand credit card. The six different credit limits may include, for example, two hundred dollars, five hundred dollars, one thousand dollars, two thousand dollars, five thousand dollars and ten thousand dollars. The six different interest rates may include, for example, 0.0%, 4.9%, 7.9% 10.9%, 12.9%, 17.9% and 22.9%.

In some embodiments, the plurality of possible payment card accounts may include all possible combinations of the card types, credit limits and interest rates available from the financial institution. For example, if there are two different types of payment cards, six different credit limits and seven different interest rates, there may be a total of eighty four possible payment card accounts, i.e., 2×6×7.

In some other embodiments, the plurality of possible payment card accounts may include fewer than all possible combinations of the card types, credit limits and interest rates available from the financial institution. For example, in some other embodiments, one or more types of cards may not be available with one or more of the credit limits and/or one or more of the interest rates. In some embodiments, one or more types of cards, credit limits and/or interest rates may not be available unless the customer data satisfies certain financial criteria.

In some embodiments, the possible payment card account data may be predetermined, dynamically determined and/or a combination thereof. In that regard, in some embodiments, the possible account generator 302 may generate one or more of the possible payment card accounts based at least in part on data indicative of one or types of payment cards, credit limits and/or interest rates that may be available from the financial institution and/or one or more possible payment card account criteria, which may include one or more rules that may be used to define valid combinations of card types, credit limits and/or interest rates for a customer. Such data and/or criteria may be supplied by any source or sources, which may include, but is not limited to the possible account generator 302 itself. Some embodiments may not include a possible account generator 302, but rather may receive the possible payment card data from another source or sources.

The customer data and the possible payment card account data may be provided to the estimator 304, which may determine one or more estimates of one or more financial metrics that would be realized by giving the customer an account having the characteristics of one or more of the possible payment card accounts. In accordance with some embodiments, the estimator 304 may determine one or more of the estimates based, at least in part, on the customer data (i.e., one or more characteristics of the customer), the possible payment card account data (i.e., one or more characteristics of the possible payment card account) and/or historical data.

In some embodiments, the one or more financial metrics may include (1) an estimate of profit that would be realized by the financial institution as a result of giving the customer an account having the characteristics of such possible payment card account, (2) an estimate of sales that would be realized by the retail business or bank as a result of giving the customer an account having the characteristics of such possible payment card account and/or (3) an estimate of loss that would be realized by the financial institution as a result of giving the customer an account having the characteristics of such possible payment card account.

In accordance with some embodiments, the estimator 304 may determine the following estimates for each of the possible payment card accounts (1) an estimate of profit that would be realized by the financial institution as a result of giving the customer an account having the characteristics of such possible payment card account, (2) an estimate of sales that would be realized by the retail business as a result of giving the customer an account having the characteristics of such possible payment card account and/or (3) an estimate of loss that would be realized by the financial institution as a result of giving the customer an account having the characteristics of such possible payment card account.

For example, if there are eighty four possible payment card accounts, the estimator may determine (1) eighty four estimates of profit that would be realized by the financial institution as a result of giving the customer an account having the characteristics of such possible payment card account, (2) eighty four estimates of sales that would be realized by the retail business as a result of giving the customer an account having the characteristics of such possible payment card account and/or (3) eighty four estimates of loss that would be realized by the financial institution as a result of giving the customer an account having the characteristics of such possible payment card account.

In some embodiments, profit may be expressed by the following formula:

profit=finance charge+other charges+interchange revenue−sales expense−bad debt

where

finance charge represents interest charges,

other charges represents late fees, overlimit fees and/or other miscellaneous fees (e.g. annual fee, credit insurance fee, etc.),

interchange revenue represents a fee paid by the retail business and/or other merchant that accepts the card as payment,

sales revenue represents a commission paid to the retail business for out of store sales, and

bad debt represents debt that is non-collectible.

In some embodiments, the possible payment card account data and the estimates of the financial metrics for the one or more possible payment card accounts may be supplied to the selector 306. In accordance with some embodiments, the selector 306 may select one of such possible payment card accounts based at least in part on the estimates of the financial metrics for the one or more possible payment card accounts and/or one or more selection criteria. Any type and/or number of selection criteria may be employed. In some embodiments, the one or more selection criteria includes one or more criteria related to a financial metric of the retail business.

In some embodiments, the processing system 202 may not approve the account unless there is a likelihood that the account, if approved, would result in a profit for the financial institution. In some embodiments, processing system 202 may approve the account even if there is a likelihood that the account would result in no profit and/or a loss for the financial institution.

In some embodiments, the processing system may select a credit limit and/or interest rate that helps maximizes sales of the retail business. In that regard, in some embodiments, the estimator 306 may (a) identify one of the plurality of estimates of sales that has a greatest magnitude and (b) select a possible payment card account associated with the estimate that has the greatest magnitude. In some embodiments, the one or more selection criteria may cause the selector 306 to not select the possible payment card account for which the estimate of profit is greatest. In some embodiments, the one or more selection criteria may cause the selector 306 to not select the possible payment card account for which the estimate of loss is least. In some embodiments, the selection criteria may cause the selector 306 to select a possible payment card account for which the estimate of profit is less than or equal to zero and/or a possible payment card account for which the estimate of loss is greater than zero.

In some embodiments, the selector 306 may select a possible payment card account with a credit limit and/or interest rate that helps maximize profit for the financial institution.

In some embodiments, the selected possible payment card account may be used in association with offering, establishing and/or changing a payment card account. In is that regard, in some embodiments, the processing system 202 may initiate an offer for a payment card account for the customer 204, where the payment card account has the at least one characteristic of the selected one of the plurality of possible payment card accounts. In some embodiments, the processing system 202 may establish a payment card account for the customer 204, where the payment card account has the at least one characteristic of the selected one of the plurality of possible payment card accounts. In some embodiments, the processing system 202 may change a payment card account of the customer to have the one or more characteristics of the selected one of the possible payment card accounts.

A decision regarding the account may be supplied to the customer 204 via one or more channels of communication 206. As stated above, one or more methods of communication may be more effective in one or more regards than one or more other methods of communication. In some embodiments, the processing system 202 may select the one or more channels of communication to be used to communicate the decision. In some embodiments, the processing system 202 may select a method to which the customer 204 is likely to respond most favorably. In some embodiments, the one or more channels of communication 206 may include, but is not be limited to, one or more methods of communication disclosed herein.

In some embodiments, a decision may comprise an offer for a payment card account where the payment card account has the at least one characteristic of the selected one of the plurality of possible payment card accounts. In some embodiments, a decision may comprise a decision to establish a payment card account for the customer, where the payment card account has the at least one characteristic of the selected one of the plurality of possible payment card accounts. In some embodiments, a decision may comprise a decision to change a payment card account for the customer to have the at least one characteristic of the selected one of the plurality of possible payment card accounts.

In some embodiments, the processing system 202 may included fewer than all of the portions disclosed herein and/or one or more other portions in addition thereto.

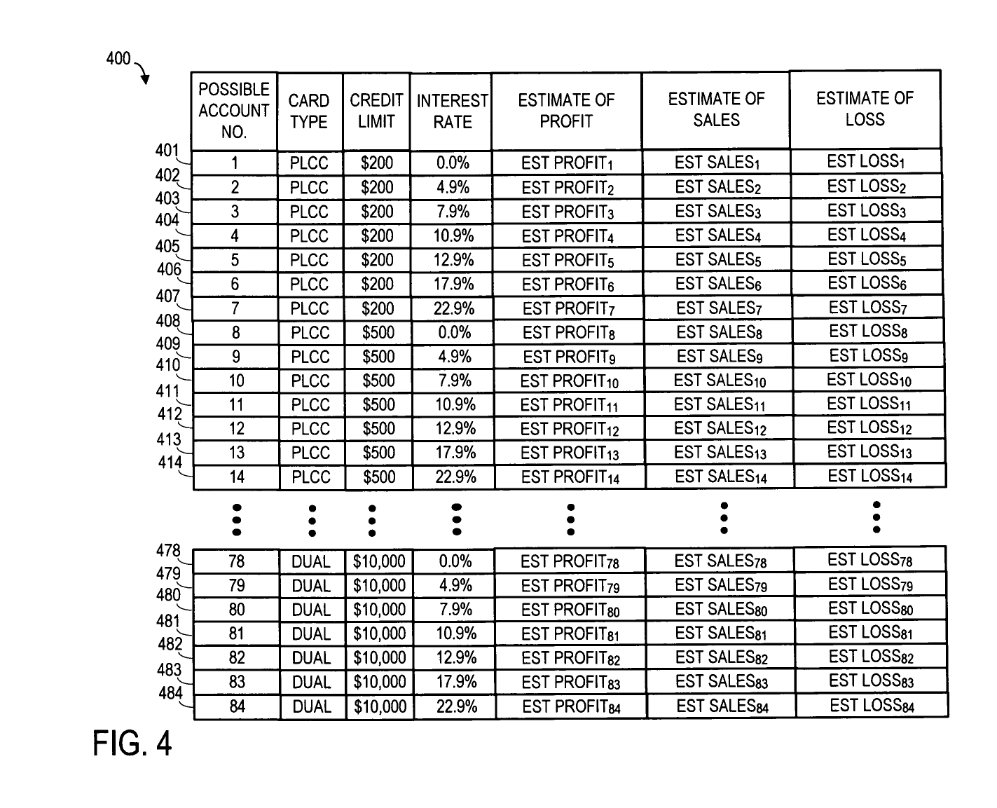

FIG. 4 is a table 400 of a plurality of possible payment card accounts and estimates of financial metrics that may be generated for such possible payment card accounts in some embodiments. Referring to FIG. 4, the table 400 includes a plurality of rows or entries, e.g., entries 401-484, each of which represents a possible payment card account and estimates of three financial metrics that may be realized as a result of giving the customer an account having the characteristics of such possible payment card account.

For example, a first entry 401 represents a first possible payment card account, which may include a first type of payment card, a first credit limit and a first interest rate. The second entry 402 represents a second possible payment card account, which may include the type of payment card, the first credit limit and a second interest rate. The third entry 403 represents a third possible payment card account, which may include the first type of payment card, the first credit limit and a third interest rate. The fourth entry 404 represents a fourth possible payment card account, which may include the first type of payment card, the first credit limit and a fourth interest rate. The fifth entry 405 represents a fifth possible payment card account, which may include the first type of payment card, the first credit limit and a fifth interest rate. The sixth entry 406 represents a sixth possible payment card account, which may include the first type of payment card, the first credit limit and a sixth interest rate. The seventh entry 407 represents a seventh possible payment card account, which may include the first type of payment card, the first credit limit and a seventh interest rate.

The eighth entry 408 represents a eighth possible payment card account, which may include the first type of payment card, a second credit limit and the first interest rate. The ninth entry 409 represents a ninth possible payment card account, which may include the first type of payment card, the second credit limit and the second interest rate. The tenth entry 410 represents a tenth possible payment card account, which may include the first type of payment card, the second credit limit and the third interest rate. The eleventh entry 411 represents an eleventh possible payment card account, which may include the first type of payment card, the second credit limit and the fourth interest rate. The twelfth entry 412 represents a twelfth possible payment card account, which may include the first type of payment card, the second credit limit and the fifth interest rate. The thirteenth entry 413 represents a thirteen possible payment card account, which may include the first type of payment card, the second credit limit and the sixth interest rate. The fourteenth entry 414 represents a fourteenth possible payment card account, which may include the first type of payment card, the second credit limit and the seventh interest rate.

The seventy eighth entry 478 represents a seventy eighth possible payment card account, which may include a second type of payment card, a sixth credit limit and the first interest rate. The seventy ninth entry 479 represents a seventy ninth possible payment card account, which may include the second type of payment card, the sixth credit limit and the second interest rate. The eightieth entry 480 represents an eightieth possible payment card account, which may include the second type of payment card, the sixth credit limit and the third interest rate. The eighty first entry 481 represents an eleventh possible payment card account, which may include the second type of payment card, the sixth credit limit and the fourth interest rate. The eighty second entry 482 represents an eighty second possible payment card account, which may include the second type of payment card, the sixth credit limit and the fifth interest rate. The eighty third entry 483 represents an eighty third possible payment card account, which may include the second type of payment card, the sixth credit limit and the sixth interest rate. The eighty fourth entry 484 represents a eighty fourth possible payment card account, which may include the second type of payment card, the sixth credit limit and the seventh interest rate.

In accordance with some embodiments, the two different types of payment cards may include a private label payment card and a dual card and/or a co-brand credit card. The six different credit limits may include, for example, two hundred dollars, five hundred dollars, one thousand dollars, two thousand dollars, five thousand dollars and ten thousand dollars. The six different interest rates may include, for example, 0.0%, 4.9%, 7.9% 10.9%, 12.9%, 17.9% and 22.9%.

As stated above, each of the plurality of entries further includes estimates of three financial metrics that may be realized as a result of giving the customer an account having the characteristics of such possible payment card account. The three financial metrics may include (1) an estimate of profit that would be realized by the financial institution as a result of giving the customer an account having the characteristics of such possible payment card account, (2) an estimate of sales that would be realized by the retail business as a result of giving the customer an account having the characteristics of such possible payment card account and/or (3) an estimate of loss that would be realized by the financial institution as a result of giving the customer an account having the characteristics of such possible payment card account.

As stated above, in some embodiments, only one type of payment card account may be available. In such embodiments, the one type of payment card account may be a private label credit card account, a dual card account, a co-brand credit card account and/or any other type of payment card account. In some embodiments, more than one type of payment card account may be available. In such embodiments, such more than one type of payment card account may include a private label credit card account, a dual card account, a co-brand credit card account and/or any other type(s) of payment card account(s).

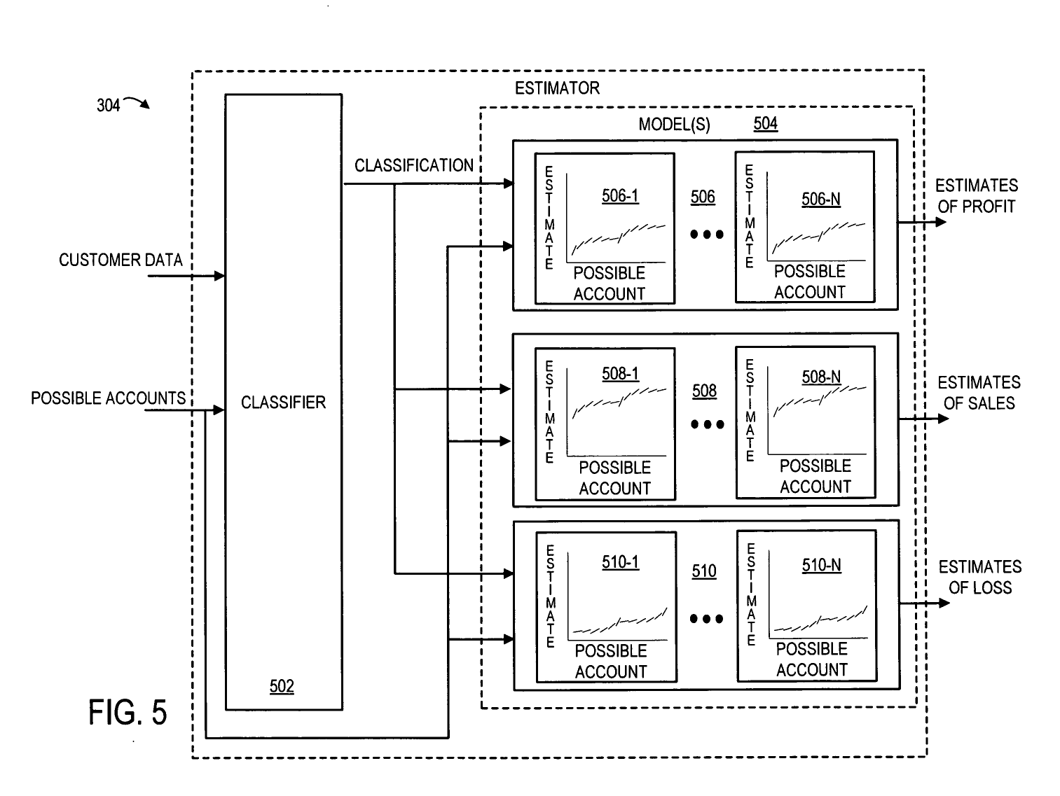

FIG. 5 is a block diagram of the estimator 304 in accordance with some embodiments. Referring to FIG. 5, in some embodiments, the estimator 304 comprises a classifier 502 and one or more models 504. The classifier 502 may receive the customer data and may determine a classification of the customer based, at least in part, on the customer data and one or more classification criteria. In some embodiments, for example, the customer may be classified as a first classification if the customer data satisfies a first criteria, a second classification if the customer data satisfied a second criteria, a third classification if the customer data satisfies a third criteria, and so on. In some embodiments, the number of classifications is at least fifty and/or in a range between fifty and one hundred. In some embodiments, the one or more classification criteria may comprise one or more regression techniques, which may include, but are not limited to, regression analysis, regression modeling and regression algorithms, that may define customers that have similar characteristics.

The classification of the customer may be supplied to the one or more models 504, which may also receive the possible payment card account data and which may determine the estimates of one or more financial metrics that would be realized as a result of giving the customer an account having the characteristics of one or more of such possible payment card accounts. In some embodiments, customers in the same classification may be the same and/or similar to one another in regard to one or more characteristics, although there may not be a requirement that the customers be the same and/or similar to one another in regard to all characteristics.

In some embodiments, the one or more models 504 include a first model 506, a second model 508 and a third model 510. The first model 506 may determine the estimates of profit that would be realized as a result of giving the customer an account having the characteristics of one or more of such possible payment card accounts. In some embodiments, the first model 506 may comprise a mathematical fitting function that determines the estimate of profit. The second model 508 may determine the estimates of sales that would be realized by the retail business as a result of giving the customer an account having the characteristics of one or more of such possible payment card accounts. In some embodiments, the second model 508 may comprise a mathematical fitting function that determines the estimate of sales. The third model 510 may determine the estimates of loss that would be realized as a result of giving the customer an account having the characteristics of one or more of such possible payment card accounts. In some embodiments, the third model 510 may comprise a mathematical fitting function that determines the estimate of loss.

As stated above, the estimates of the financial metrics may depend at least in part on the characteristics of the customer associated with the customer data. In that regard, in some embodiments, each model may include a plurality of models, each of which may be adapted to be used to determine estimates of financial metrics that would be realized as a result of giving an account to a respective classification of customer.

For example, the first model 506 may include models 506-1 through 506-N. The first such model 506-1 may be used to determine the estimate of the profit that would be realized as a result of giving an account to a customer in the first classification. The Nth such model 506-N may be used to determine the estimate of the profit that would be realized as a result of giving an account to a customer in an Nth classification.

The second model 508 may include models 508-1 through 508-N. The first such model 508-1 may be used to determine the estimate of the sales that would be realized as a result of giving an account to a customer in the first classification. The Nth such model 508-N may be used to determine the estimate of the sales that would be realized as a result of giving an account to a customer in the Nth classification.

The third model 510 may include models 510-1 through 510-N. The first such model 510-1 may be used to determine the estimate of the loss that would be realized as a result of giving an account to a customer in the first classification. The Nth such model 510-N may be used to determine the estimate of the loss that would be realized as a result of giving an account to a customer in the Nth classification.

In some embodiments, the one or more models 504 include one or more unique models that may be generated by the estimator for a particular customer. Such unique model is sometimes referred to hereinafter as an account level model.

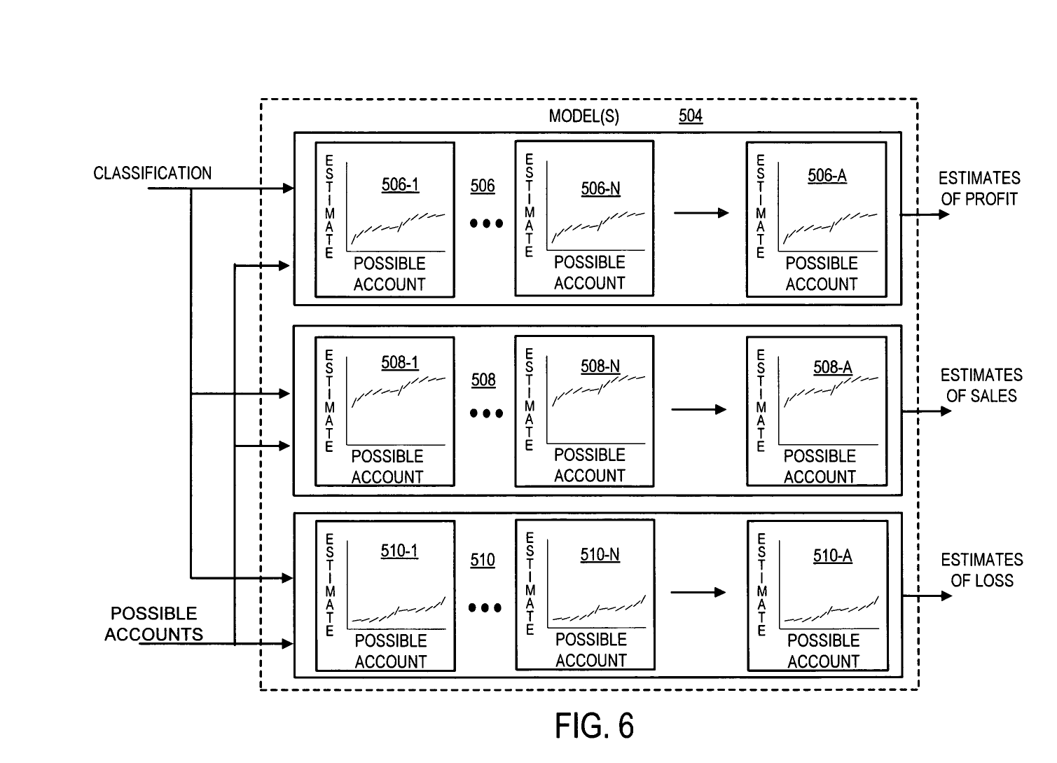

In that regard, FIG. 6 is a block diagram of the one or more models 504 in accordance with some embodiments. Referring to FIG. 6, in some embodiments, the first model 506, the second model 508 and the third model 510 may include a first account level model 506-A, a second account level model 508-A and a third account level model 510-A, respectively, which may be generated by the processing system (e.g., by the estimator of the processing system) for a particular customer.

The first account level model 506-A may used to determine the estimates of profit that would be realized as a result of giving the customer an account having the characteristics of one or more of such possible payment card accounts. The second model account level model 508-A may be used to determine the estimates of sales that would be realized by the retail business as a result of giving the customer an account having the characteristics of one or more of such possible payment card accounts. The third account level model 510-A may be used to determine the estimates of loss that would be realized as a result of giving the customer an account having the characteristics of one or more of such possible payment card accounts.

In some embodiments, the availability of an account level model may improve the estimates determined by the one or models 504. As further described hereinafter, in some embodiments, the first account level model 506-A, the second account level model 508-A and the third account level model 510-A may be based at least in part, on the first model 506, the second model 508 and the third model 510, respectively.

In accordance with some embodiments, a model may have any form, for example, but not limited to, a mathematical fitting function, a look-up table, a “curve read”, a response surface, a formula, hardwired logic, fuzzy logic, neural networks, and/or any combination thereof, Moreover, a model may be embodied, for example, in software, hardware, firmware or any combination thereof.

In some embodiments, a model may be based at least in part on one or more input/output combinations, sometimes referred to herein as a “data set”. In some embodiments, each input/output combination or “data set” may include one or more input values and one or more output values associated therewith.

In some embodiments, the one or more input/output combinations may comprise historical data. Historical data may include but is not limited to historical data associated with one or more current and/or previous accounts, which may include, but is not limited to (1) customer data of one or more customers having the one or more current and/or previous accounts, (2) purchasing data, payment data, delinquency data and/or other customer behavior data in regard to the one or more current and/or previous accounts and/or (3) data indicative of the account type(s), credit limit(s) and/or interest rate(s) of the one or more current and/or previous accounts. The one or more current and/or previous accounts may include, but are not limited to, one or more other private label credit card, dual card, co-brand credit card and/or bank payment card accounts, which may or may not be underwritten and/or managed by the financial institution.

In some embodiments, the data sets may be input to a statistical package to produce one or more formulas for use in determining one or more output values based on one or more inputs. In some embodiments, a formula may have the ability to generate an output for any input combination within a range of interest. In some embodiments, the data sets may be used to create a look-up table that provides one or more outputs values for each combinations of input(s). In some embodiments, a look-up table may be responsive to absolute magnitudes and/or relative differences.

A model may be predetermined and/or dynamically determined. In some embodiments, one or more portions of a mapping may be generated “off-line”. In some embodiments, after one or more portions of a model are generated, use of the model may entail considerably less processing overhead than that may be required without the mapping.

In some embodiments, interpolation and/or extrapolation may be used to determine an appropriate output for any input combination not in a model, e.g., not in a table and/or “curve read”.

In some embodiment, the one or more models are generated using data sets collected over a period of time, e.g., a six month time period. In some embodiments, an adaptive model may be used wherein the model is trained, retrained, and/or adapted over time.

In some embodiments, it may be possible to improve the estimates of the one or models by generating the one or more models based at least in part, on data sets collected over a longer period of time, e.g., a one year, two year or longer periods, which may thus encompass a greater percentage of all possible input/output combinations. In that regard, in some embodiments, one or more new models may be generated at one or more times. In some embodiments, one or more new models may be generated at periodic intervals. In some other embodiments, one or more new models may be generated at non periodic intervals.

As stated above, in some embodiments, the first account level model 506-A, the second account level model 508-A and the third account level model 510-A may be based at least in part, on the first model 506, the second model 508 and the third model 510, respectively.

If the processing system 202 generates an account level model for a customer in a first classification, the account level model may be based, at least in part on historical data associated with customers in the first classification. Thus, an account level model used to determine a financial metric for a customer in the Nth classification may be based at least in part on historical data associated with customers in the Nth classification.

In some embodiments, an account level model for a customer may be generated based at least in part on (a) one or more of the one or more models 504 and (b) differences between the characteristics of the customer and the characteristics of the one or more customers of the one or more current and/or previous accounts used in generating the one or more of the one or more models 504.

In that regard, in some embodiments, the model 506 may include models 506-1 through 506-N, associated with classifications 1-N, respectively, and an account level model for a customer in the Mth classification, where M is greater than or equal to one and less than or equal to N, may be generated based at least in part on (a) the Mth model 506-M associated with the Mth classification, and (b) differences between the characteristics of the customer and the characteristics of the one or more customers of the one or more current and/or previous accounts used in generating the Mth model 506-M. Thus, if the customer is in the first classification, the account level model 506-A may be generated based on (a) the first model 506-1 and (b) differences between the characteristics of the customer and the characteristics of the one or more customers of the one or more current and/or previous accounts used in generating the first model 506-1. If the customer is in the Nth classification, the account level model 506-A may be generated based on (a) the Nth model 506-N and (b) differences between the characteristics of the customer and the characteristics of the one or more customers of the one or more current and/or previous accounts used in generating the Nth model 506-N.

Likewise, in some embodiments, the model 507 may include models 507-1 through 507-N associated with classifications 1-N, respectively, and an account level on (a) the Mth model 507-M, and (b) differences between the characteristics of the customer and the characteristics of the one or more customers of the one or more current and/or previous accounts used in generating the Mth model 507-M. Thus, if the customer is in the first classification, the account level model 507-A may be generated based on (a) the first model 507-1 and (b) differences between the characteristics of the customer and the characteristics of the one or more customers of the one or more current and/or previous accounts used in generating the first model 507-1. If the customer is in the Nth classification, the account level model 507-A may be generated based on (a) the Nth model 507-N and (b) differences between the characteristics of the customer and the characteristics of the one or more customers of the one or more current and/or previous accounts used in generating the Nth model 507-N.

In some embodiments, the model 508 may include models 508-1 through 508-N associated with classifications 1-N, respectively, and an account level model for a customer in the Mth classification may be generated based at least in part on (a) the Mth model 508-M, and (b) differences between the characteristics of the customer and the characteristics of the one or more customers of the one or more current and/or previous accounts used in generating the Mth model 508-M. Thus, if the customer is in the first classification, the account level model 508-A may be generated based on (a) the first model 508-1 and (b) differences between the characteristics of the customer and the characteristics of the one or more customers of the one or more current and/or previous accounts used in generating the first model 508-1. If the customer is in the Nth classification, the account level model 508-A may be generated based on (a) the Nth model 508-N and (b) differences between the characteristics of the customer and the characteristics of the one or more customers of the one or more current and/or previous accounts used in generating the Nth model 508-N.

In some embodiments, the processing system 202 may be used to determine (1) a card type, credit limit interest rate, balance transfer offer and/or one or more other characteristics of an account, (2) a change to a card type, credit limit, interest rate, balance transfer offer and/or other characteristic of an account, (3) when to offer and/or establish a payment card account, (4) when to change a card type, credit limit interest rate, balance transfer offer and/or one or more other characteristics of an account and/or (5) how to communicate an offer, establishment, change, decision and/or other information in regard to an account.

In that regard, in some embodiments, each of the possible payment card accounts may comprise (1) data indicative of a time to offer and/or establish and/or change a payment card account, if the particularly possible payment card account is selected, and/or (2) data indicative of one or more methods of communicating a decision regarding a payment card account, if the particularly possible payment card account is selected. In some such embodiments, the processing system may be able to determine (1) when to offer and/or establish and/or change a payment card account, and/or (2) how to inform a customer of a decision regarding a payment card account, in a manner that is the same as and/or similar to that described above.

In some such embodiments, the one or more 504 may be generated in a manner that is the same as and/or similar to that described above. In such embodiments, the historical data may include but is not limited to historical data associated with one or more current and/or previous accounts, which may include, but is not limited to (1) customer data of one or more customers having the one or more current and/or previous accounts, (2) purchasing data, payment data, delinquency data and/or other customer behavior data in regard to the one or more current and/or previous accounts (3) data indicative of the account type(s), credit limit(s) interest rate(s) of the one or more current and/or previous accounts, (4) data indicative of one or more times that the one or more current and/or previous accounts were offered, established and/or changed and/or (5) data indicative of one or more methods of communication used to inform the one or more customers having the one or more current and/or previous accounts of one or more decisions in regard thereto.

In some embodiments, one or more of the one or more models 504 may be based at least in part on one or more of the following: Change in Sales (Average Performance Sales—Average Observation Sales), Change in Revolving Balances (Average Performance Revolving Balances—Average Revolving Balances), Probability of Activation, Probability of Respond, Probability of Balance Attrition, Probability of Bad, and/or Probability of Balance Transfer. In some embodiments, a model used in determining an estimate of profit that would be realized by the financial institution as a result of giving an account to the customer may be based at least in part on one or more of the above. In some embodiments, one or more one or more other models used in determining one or more other estimates may be based at least in part on one or more of the above.

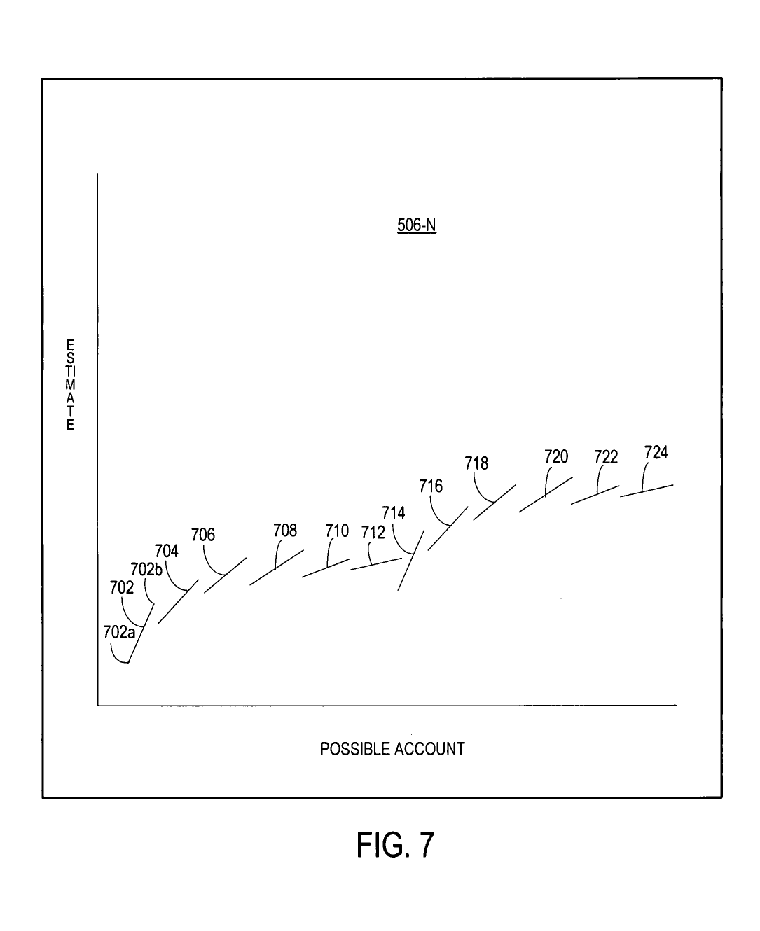

FIG. 7 is a graphical representation of a relationship defined by a model, e.g., model 506-N, in accordance with some embodiments. Referring to FIG. 7, in some embodiments, a model may define a relationship between one or more inputs and one or more outputs. In some embodiments, the one or more inputs comprises possible payment card accounts and the one or more outputs comprises estimates of a financial metric that would be realized as a result of giving an account having the characteristics of the possible payment card account to a customer. As stated above a possible payment card account may comprise an account type (e.g., private label credit card, dual card, co-brand card), a credit limit and/or an interest rated.

The relationships between the one or more inputs and the one or more outputs may include any type(s) of relationship(s), which may include, but is not limited to, linear or nonlinear, regular or irregular, continuous or non continuous, and/or combinations thereof.

In accordance with some embodiments, the possible payment card accounts may include various combinations of card types, credit limits and interest rates that may be available from the financial institution. As stated above, in some embodiments, only one type of payment card account may be available. In such embodiments, the one type of payment card account may be a private label credit card account, a dual card account, a co-brand credit card account and/or any other type of payment card account. In some embodiments, more than one type of payment card account may be available. In such embodiments, such more than one type of payment card account may include a private label credit card account, a dual card account, a co-brand credit card account and/or any other type(s) of payment card account(s).

In one illustrative embodiment, two different types of payment cards, six different credit limits and seven different interest rates may be available. The two different types of payment cards may include a private label payment card and a dual card and/or a co-brand credit card. The six different credit limits may include, for example, two hundred dollars, five hundred dollars, one thousand dollars, two thousand dollars, five thousand dollars and ten thousand dollars. The six different interest rates may include, for example, 0.0%, 4.9%, 7.9% 10.9%, 12.9%, 17.9% and 22.9%.

In some embodiments, the plurality of possible payment card accounts may include all possible combinations of the card types, credit limits and interest rates available from the financial institution. For example, if there are two different types of payment cards, six different credit limits and seven different interest rates, there may be a total of eighty four possible payment card accounts, i.e., 2×6×7.

In that regard, in some embodiments, the model may define a relationship having include twelve portions 702-724. The first portion 702 may define the portion of the input-output relationship that is associated with possible payment card accounts that include a private label credit card and a credit limit of two hundred dollars (see, for example, possible payment card accounts defined by entries 401-407 of table 400 (FIG. 4)). A first end 702a of the first portion 702 may define the portion of the input-output relationship that is associated with a possible payment card account that includes an interest rate of 17.9% (see, for example, the possible payment card account defined by entry 406 of table 400 (FIG. 4)). A second end 702b of the first portion 702 may define the portion of the input-output relationship that is associated with a possible payment card account that includes an interest rate of 0.0% (see, for example, the possible payment card account defined by entry 401 of table 400 (FIG. 4)).

20 The second portion 704 may define the portion of the input -output relationship that is associated with possible payment card accounts that include a private label credit card and a credit limit of five hundred dollars (see, for example, possible payment card accounts defined by entries 408-414 of table 400 (FIG. 4)). The third portion 706 may define the portion of the input-output relationship that is associated with possible payment card accounts that include a private label credit card and a credit limit of one thousand dollars. The fourth portion 708 may define the portion of the input-output relationship that is associated with possible credit card accounts that include a private label credit card and a credit limit of two thousand dollars. The fifth portion 710 may define the portion of the input-output relationship that is associated with possible payment card accounts that include a private label credit card and a credit limit of five thousand dollars. The sixth portion 712 may define the portion of the input-output relationship that is associated with possible payment card accounts that include a private label credit card and a credit limit of ten thousand dollars. The seventh portion 714 may define the portion of the input-output relationship that is associated with possible payment card accounts that include a dual credit card and a credit limit of two hundred dollars. The eighth portion 716 may define the portion of the input-output relationship that is associated with possible payment card accounts that include a dual credit card and a credit limit of five hundred dollars. The ninth portion 718 may define the portion of the input-output relationship that is associated with possible payment card accounts that include a dual credit card and a credit limit of one thousand dollars. The tenth portion 720 may define the portion of the input-output relationship that is associated with possible payment card accounts that include a dual credit card and a credit limit of two thousand dollars. The eleventh portion 722 may define the portion of the input-output relationship that is associated with possible payment card accounts that include a dual credit card and a credit limit of five thousand dollars. The twelfth portion 724 may define the portion of the input-output relationship that is associated with possible payment card accounts that include a dual credit card and a credit limit of ten thousand dollars (see, for example, possible payment card accounts defined by entries 478-484 of table 400 (FIG. 4)).

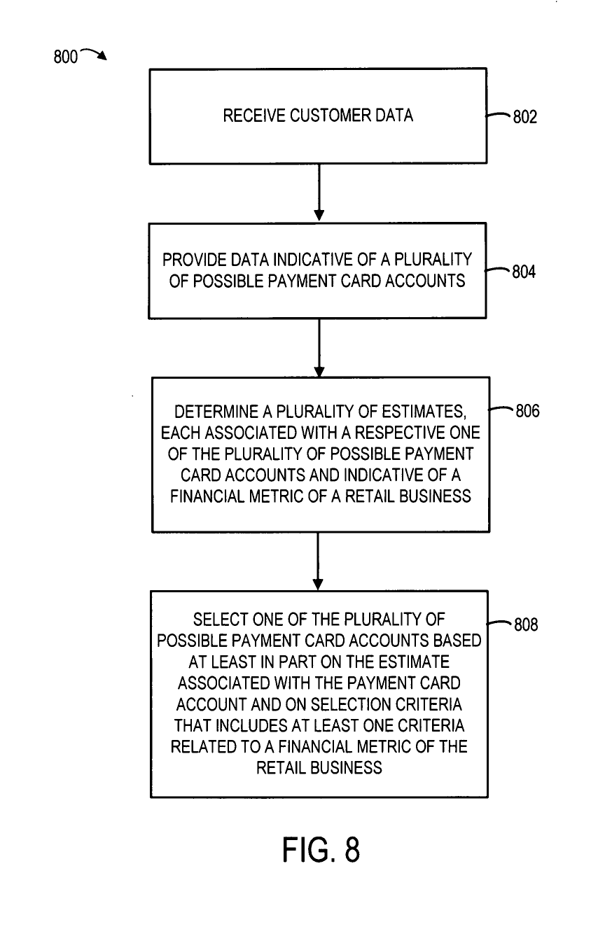

FIG. 8 is a flow chart of a process 800 according to some embodiments. In some embodiments, one or more portions of the process 800 may be performed by one or more portions of one or more embodiments of the processing system 202 (FIG. 5). Referring to FIG. 8, at 802, the process may include receiving customer data for a customer. At 804, the process may further include providing data indicative of a plurality of possible payment card accounts. Each of the possible payment card accounts may have one or more characteristics, which may include but may not be limited to, a credit limit and an interest rate. In some embodiments, one or more of the possible payment card accounts may include a private label credit card account or a dual credit card account.

At 806, the process may further include determining a plurality of estimates, each associated with a respective one of the plurality of possible payment card accounts and indicative of a financial metric of a retail business. In some embodiments, this may include (a) providing at least one model based at least in part on historical data for a plurality of accounts of a plurality of customers, and (b) determining the plurality of estimates using the at least one model. In that regard, some embodiments may include (a) classifying the customer based at least in part on criteria defining a plurality of classifications, (b) providing a plurality of models, each associated with a respective one of the plurality of classifications and (c) determining the plurality of estimates using a model of the plurality of models that is associated with the classification of the customer. In some embodiments, the customer may be classified based, at least in part, on the customer data and one or more classification criteria. Any number of classifications may be employed. As stated above, in some embodiment, the number of classifications is in a range between fifty and one hundred.

In some embodiments, each of the plurality of estimates comprises an estimate indicative of sales that would be realized by the retail business if the customer had a payment card account having the at least one characteristic of the associated one of the plurality of payment card accounts.

In some embodiments, the process may further include determining a plurality of estimates, each of the plurality of estimates being associated with a respective one of the plurality of payment card accounts and indicative of a financial metric that would be realized by the financial institution if the customer had a payment card account having the at least one characteristic of the associated one of the plurality of payment card accounts. In some embodiments, each of such plurality of estimates includes an estimate indicative of profit that would be realized by the financial institution if the customer had a payment card account having the at least one characteristic of the associated one of the plurality of payment card accounts. In some embodiments, selecting one of the plurality of payment card accounts comprises not selecting a payment card account associated with an estimate of profit that has a greatest magnitude among the plurality of estimates of profit.

At 808, the process may further include selecting one of the plurality of possible payment card accounts based at least in part on the estimate associated with the payment card account and on selection criteria that includes at least one criteria related to a financial metric of the retail business. In some embodiments, selecting a possible payment card account may include (a) identifying one of the plurality of estimates of sales that has a greatest magnitude and (b) selecting a payment card account associated with the estimate that has the greatest magnitude.

In some embodiment, the process may be used in offering, establishing and/or changing a payment card account. In that regard, the process may further include (1) offering a payment card account to the customer, where the payment card account has the at least one characteristic of the selected one of the plurality of payment card accounts, (2) establishing a payment card account for the customer, where the payment card account has the at least one characteristic of the selected one of the plurality of payment card accounts and/or (3) changing a payment card account of the customer to have the at least one characteristic of the selected one of the plurality of payment card accounts.

As stated above, in some embodiments, from time to time, a determination may be made to change one or more characteristics of an account.

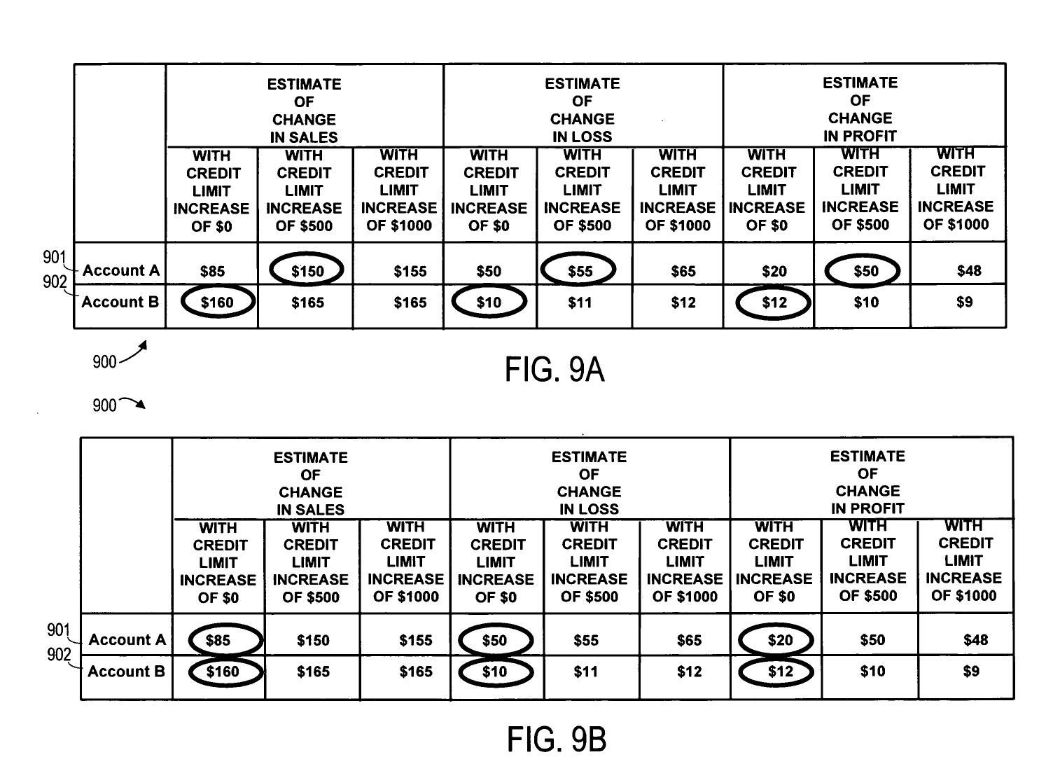

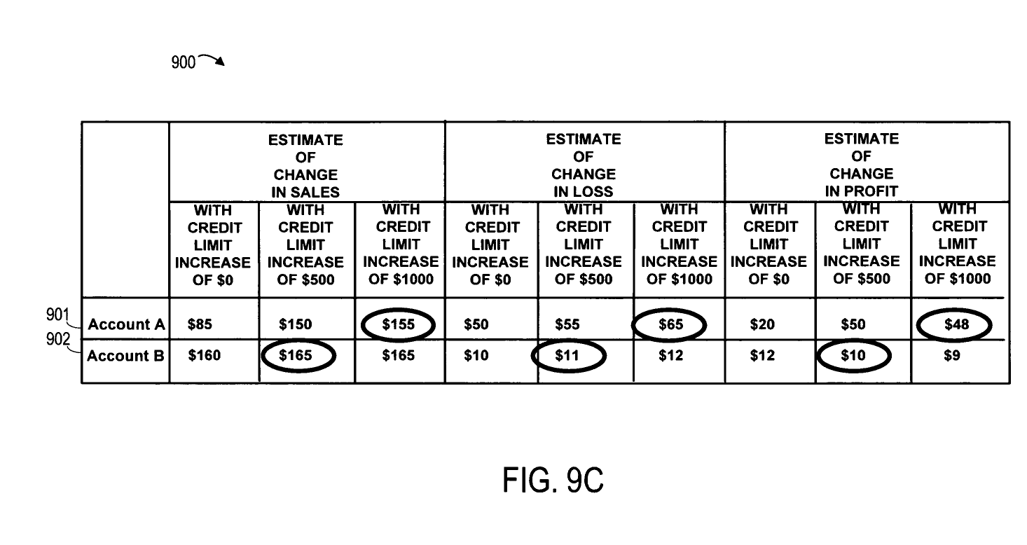

FIG. 9A is a table 900 of estimates of financial metrics that may be generated for accounts in some embodiments. Referring to FIG. 9A, the table 900 includes a plurality of entries, e.g., entries 901-902, each of which includes estimates of financial metrics that may be realized as a result of possible changes to one or more characteristics of an account.

In that regard, the first entry 901 includes estimates of financial metrics that may be realized as a result of possible changes to one or more characteristics of a first account. The estimates include (a) an estimate of a change in the sales of the retail business that may be realized as a result of a first possible change (e.g., no change) to the credit limit of the account, (b) an estimate of a change in the sales of the retail business that may be realized as a result of a second possible change (e.g., an increase of five hundred dollars) to the credit limit of the account, (c) an estimate of a change in the sales of the retail business that may be realized as a result of a third possible change (e.g., an increase of one thousand dollars) to the credit limit of the account, (d) an estimate of a change in the loss of the financial institution that may be realized as a result of the first possible change (e.g., no change) to the credit limit of the account, (e) an estimate of a change in the loss of the financial institution that may be realized as a result of the second possible change (e.g., an increase of five hundred dollars) to the credit limit of the account, (f) an estimate of a change in the loss of the financial institution that may be realized as a result of the third possible change (e.g., an increase of one thousand dollars) to the credit limit of the account, (g) an estimate of a change in the profit of the financial institution that may be realized as a result of the first possible change (e.g., no change) to the credit limit of the account, (h) an estimate of a change in the profit of the financial institution that may be realized as a result of the second possible change (e.g., an increase of five hundred dollars) to the credit limit of the account, (i) an estimate of a change in the profit of the financial institution that may be realized as a result of the third possible change (e.g., an increase of one thousand dollars) to the credit limit of the account.

The second entry 902 includes estimates of financial metrics that may be realized as a result of possible changes to one or more characteristics of a second account. The estimates include (a) an estimate of a change in the sales of the retail business that may be realized as a result of a first possible change (e.g., no change) to the credit limit of the account, (b) an estimate of a change in the sales of the retail business that may be realized as a result of a second possible change (e.g., an increase of five hundred dollars) to the credit limit of the account, (c) an estimate of a change in the sales of the retail business that may be realized as a result of a third possible change (e.g., an increase of one thousand dollars) to the credit limit of the account, (d) an estimate of a change in the loss of the financial institution that may be realized as a result of the first possible change (e.g., no change) to the credit limit of the account, (e) an estimate of a change in the loss of the financial institution that may be realized as a result of the second possible change (e.g., an increase of five hundred dollars) to the credit limit of the account, (f) an estimate of a change in the loss of the financial institution that may be realized as a result of the third possible change (e.g., an increase of one thousand dollars) to the credit limit of the account, (g) an estimate of a change in the profit of the financial institution that may be realized as a result of the first possible change (e.g., no change) to the credit limit of the account, (h) an estimate of a change in the profit of the financial institution that may be realized as a result of the second possible change (e.g., an increase of five hundred dollars) to the credit limit of the account, (i) an estimate of a change in the profit of the financial institution that may be realized as a result of the third possible change (e.g., an increase of one thousand dollars) to the credit limit of the account.

In accordance with some embodiments, a change to the credit limit (and/or any other characteristic or characteristics) of one or more accounts, e.g., the first account and/or the second account, may be determined in accordance with one or more criteria. In some embodiments, the one or more criteria may represent a strategy for achieving one or more objectives. The one or more objectives may include but are not limited to: (1) maximizing profit, (2) limiting the number of accounts that receive an increase in the credit limit to a predetermined percentage of the number of accounts (e.g., less than or equal to fifteen percent of accounts), (3) limiting the estimate of loss to a predetermined percentage (e.g., less than or equal to six percent), (4) limiting any increase in the credit limit to a predetermined percentage of the credit limit (e.g., less than or equal to twenty percent) and/or (5) limit the increase in the credit limit to one thousand dollars if the credit score (or risk score) for the customer is less than a predetermined value (e.g., seven hundred).

In some embodiments, the processing system 202 may include software, sometimes referred to as optimization software, that may determine one or more changes to be made to an account in accordance with the one or more criteria. Examples of standard optimization software may include but are not limited to SOLVER provided by SAS, MARKETSWITCH provided by EXPERIAN and DECISION OPTIMIZER provided by FAIR ISMC.

FIG. 9A shows changes that may be made if the objective is maximizing profit without any additional constraints. It can be seen that the maximum estimate of profit for the first account is associated with the second possible change (e.g., an increase of five hundred dollars) to the credit limit of first account. It can also be seen that the maximum estimate of profit for the second account is associated with the first possible change (e.g., no change) to the credit limit of second account. Thus, the change to the credit limit of the first account may be the second possible change (e.g., an increase of five hundred dollars). The change to the credit limit of the second account may be the first possible change (e.g., no change).

FIG. 9B shows changes that may be made in some embodiments if the one or more objectives include a primary objective of minimizing loss and a secondary objective of maximizing profit, sometimes referred to herein as maximizing profit while minimizing loss. It can be seen that any increase in the credit limit of the first account results in an increase in the estimate of loss for the first account. It can also be seen that any increase in the credit limit of the second account results in an increase in the estimate of loss for the second account. Thus, the change to the credit limit of the first account may be the first possible change (e.g., no change). The change to the credit limit of the second account may be the first possible change (e.g., no change).

FIG. 9C shows changes that may be made in some embodiments if the one or more objectives includes a primary objective of maximizing sales and a secondary objective of maximizing profit, sometimes referred to herein as maximizing profit while maximizing sales. It can be seen that the maximum estimate of sales for the first account is associated with the third possible change (e.g., an increase of one thousand dollars) to the credit limit of first account. It can also be seen that the maximum estimate of sales for the second account is associated with either the second possible change (e.g., an increase of five hundred dollars) and the third possible change (e.g., an increase of one thousand dollars) to the credit limit of second account. The estimate of profit for the second account is higher for the second possible change (e.g., an increase of five hundred dollars) than for the third possible change (e.g., an increase of one thousand dollars). Thus, the change to the credit limit of the first account may be the third possible change (e.g., an increase of one thousand dollars). The change to the credit limit of the second account may be the second possible change (e.g., an increase of five hundred dollars).

In some embodiments, one or more of the one or more models and/or one or more of the one or more criteria may be evaluated and/or revised from time to time.

In that regard, one or more reports may be generated to help determine whether such model(s) and/or criteria are working, i.e., achieving one or more desired objectives. In some embodiments, the report may comprise an effectiveness reports and/or a concentration report. An effectiveness report may compare one or more performance metrics (e.g., incremental sales, incremental balances) for accounts that were changed to one or more performance metrics for accounts that were not changed. A concentration report may show profile a strategy in terms of multiple profiling variables (some of them represent current behavior and others represent future expected behavior).

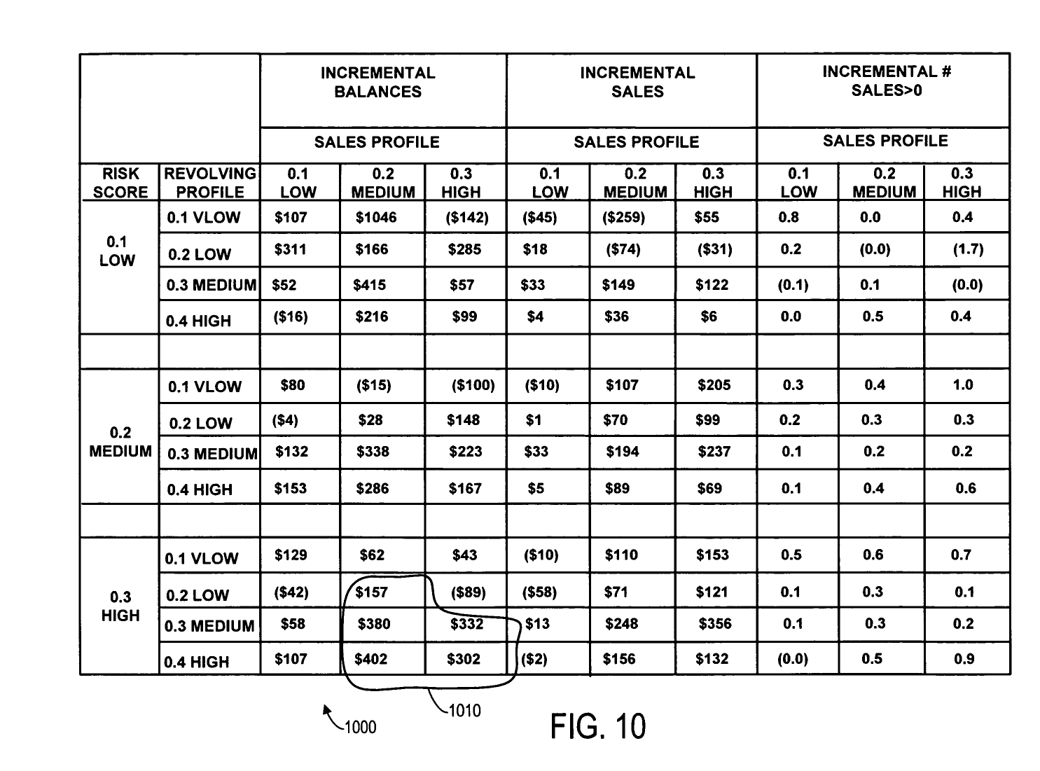

FIG. 10 shows one embodiment of an effectiveness report 1000. Referring to FIG. 10, in some embodiments, an effectiveness report 1000 may include three sections labeled incremental balances, incremental sales and incremental # sales, respectfully. The incremental balance section may compare balances for accounts that were changed to balances for accounts that were not changed. The incremental sales section may compare sales for the accounts that were changed to sales for the accounts that were not changed. The incremental # sales section may compare the number of sales for the accounts that were changed to the number of sales for the accounts that were not changed.

More particularly, each value in the incremental balances section is indicative of a difference between (a) an average balance of accounts that are in a certain class and were changed during a period and (b) an average balance of accounts that are in the class and were not changed during the period. Each value in the incremental sales section is indicative of a difference between (a) an average of sales for accounts that are in a certain class and were changed during a period and (b) an average of sales for accounts that are in the class and were not changed during the period. Each value in the incremental # sales section is indicative of a difference between (a) an average of the number of sales for accounts that are in a certain class and were changed during a period and (b) an average of the number of sales for accounts that are in the class and were not changed during the period.

To generate the report 1000 each account may be classified according one or more criteria. In some embodiments, the one or more criteria include the account's risk score (e.g., low, medium, high), its revolving balance (e.g., very low, low, medium, high) and/or its sales (e.g., low, medium, high). If there are three classes of risk score, four classes of revolving balance and three classes of sales, there may be a total of thirty six different combinations or classifications, i.e., 3×4×3. The thirty six classifications may include: (1) low risk score, very low revolving balance and low sales, (2) low risk score, very low revolving balance and medium sales, (3) low risk score, very low revolving balance and high sales, (4) low risk score, low revolving balance and low sales, (5) low risk score, low revolving balance and medium sales, (6) low risk score, low revolving balance and high sales, (7) low risk score, medium revolving balance and low sales, (8) low risk score, medium revolving balance and medium sales, (9) low risk score, medium revolving balance and high sales, (10) low risk score, low risk score, high revolving balance and low sales, (11) low risk score, high revolving balance and medium sales and (12) low risk score, high revolving balance and high sales, (13) medium risk score, very low revolving balance and low sales, (14) medium risk score, very low revolving balance and medium sales, (15) medium risk score, very low revolving balance and high sales, (16) medium risk score, low revolving balance and low sales, and so on.

If there are thirty two classes of accounts, each section of the report 1000 may include thirty two values, i.e., one for each class of account. For example, the incremental balances section of the report may include thirty two values. The first value may be indicative of a difference between (a) an average balance of accounts that are low risk score, very low revolving balance and low sales and were changed during a period and (b) an average balance of accounts that are low risk score, very low revolving balance and low sales and were not changed during the period. The second value may be indicative of a difference between (a) an average balance of accounts that are low risk score, very low revolving balance and medium sales and were changed during a period and (b) an average balance of accounts that are low risk score, very low revolving balance and medium sales and were not changed during the period. And so on.

Thus, in some embodiments, one or more performance metrics may be determined for accounts that were changed, and such performance metric(s) may be compared to one or more performance metrics for accounts that were not changed. In such embodiments, the accounts that were not changed may be used a control group to help determine the effectiveness of one or more strategies that may have been employed in the course of determining one or more changes to the first plurality of accounts.

In some embodiments, customers having a high revolving balance may be more responsive to credit limit increases than customers having a low or very low revolving balance. See for example, a plurality of values 1010.

Note that in table 1000, a high risk score represents less risk than a low risk score. Thus, in some embodiments, risk score may be indirectly proportional to an amount of risk associated with an account. In some other embodiments, risk score may be directly proportional to an amount of risk associated with an account.

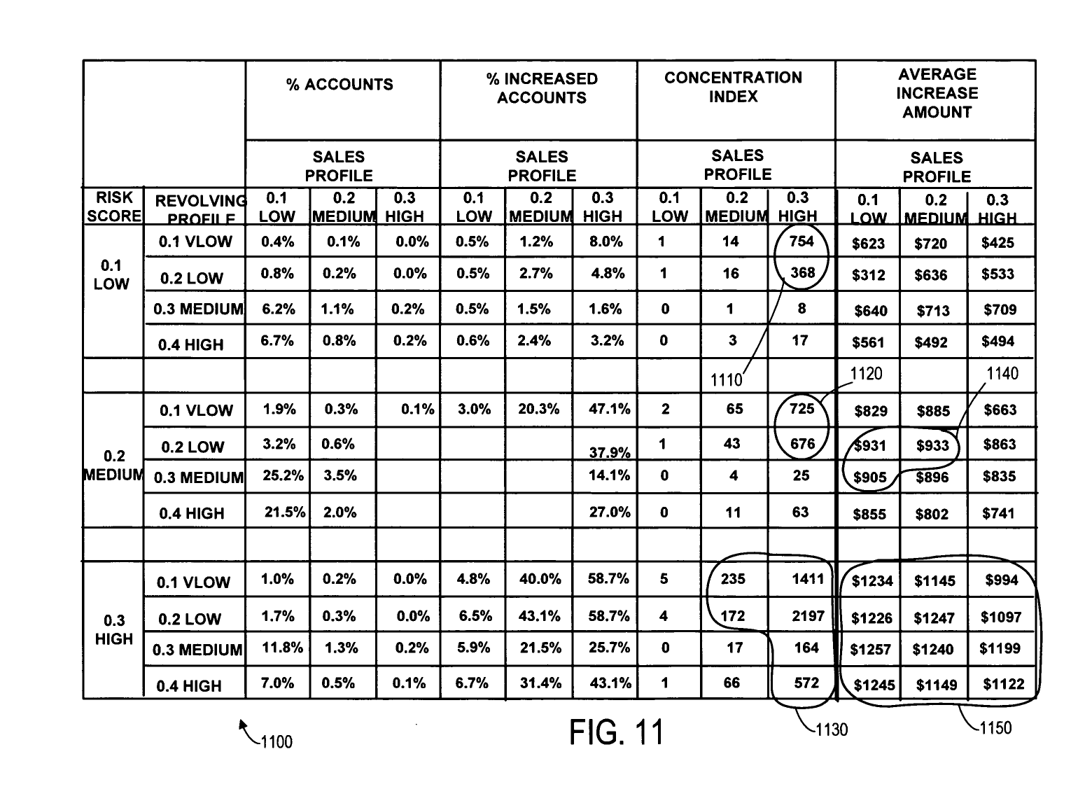

FIG. 11 shows one embodiment of a concentration report 1100. In accordance with some embodiments, the report 1100 may include four sections labeled % accounts, % increased accounts, concentration index and average increase amount, respectfully. Each value in the % accounts section indicates the percentage of accounts that are in a certain classification. Each value in the % increase accounts section indicates the percentage of such accounts (i.e., the accounts in the certain classification) that were changed. Each value in the average increase amount section indicates an average of the credit limit increases that were made to such accounts (i.e., the accounts in the certain classification) that were changed. Each value in the concentration index section is determined by dividing the value in the % increased accounts section by the % accounts section. Thus, the concentration index measures to what degree a strategy targets (or avoids) accounts in a certain classification.

To generate the report 1100 each account may be classified according one or more criteria. In some embodiments, the one or more criteria include the account's risk score (e.g., low, medium, high), its revolving balance (e.g., very low, low, medium, high) and/or its sales (e.g., low, medium, high), for example, as described above with respect to table 1000 of FIG. 10.

If there are thirty two classes of accounts, each section of the report 1100 may include thirty two values, i.e., one for each class of account. For example, the % accounts section of the report 1100 may include thirty two values. The first value may be indicative of the percentage of accounts that are in a class that includes low risk score, very low revolving balance and low sales. The second value may be indicative of the percentage of accounts that are in a class that includes low risk score, very low revolving balance and medium sales. And so on.

As indicated in table 1100, some embodiments may have one or more of the following objectives: (1) increasing the credit limit of accounts associated of high spenders with a good risk profile, (2) providing similar credit line increases to all of such accounts that are changed. See for example, a first plurality of values 1110, second plurality of values 1120, third plurality of values 1130, fourth plurality of values 1140 and fifth plurality of values 1150. In some embodiment and/or (3) not increasing the credit limit of many accounts that are not a good risk and/or do not have a low revolving balance.

As stated above with respect to table 1100, in table 1100, a high risk score represents less risk than a low risk score. In some other embodiments, a high risk score may represent more risk than a low risk score.

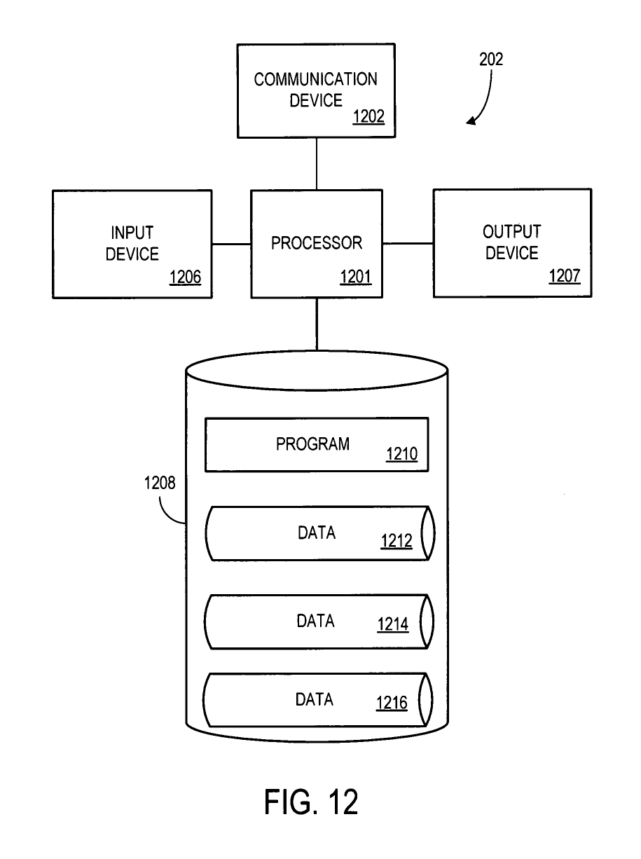

FIG. 12 is a block diagram of a one embodiment of the processing system 202. In some embodiments, the processing system 202 may be used to carry out one or more portions of one or more processes disclosed herein. Referring to FIG. 12, in some embodiments, the processing system 202 includes a processor 1201 operatively coupled to a communication device 1202, an input device 1206, an output device 1207 and a storage device 1208. The communication device 1202 may be used to facilitate communication with, for example, other devices, one or more retail businesses and/or one or more customers. The input device 1206 may comprise, for example, one or more devices used to input data and information, such as, for example: a keyboard, a keypad, a mouse or other pointing device, a microphone, knob or a switch, an infra-red (IR) port, etc. The output device 1207 may comprise, for example, one or more devices used to output data and information, such as, for example: an IR port, a docking station, a display, a speaker, and/or a printer, etc. The storage device 1208 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 1208 may store one or more programs 1210, which may include one or more instructions to be executed by the processor 1201 to perform one or more portions of one or more embodiments disclosed herein.

In some embodiments, one or more of the programs 1210 may include one or more criteria employed in one or more processes and/or one or more systems disclosed herein.

In some embodiments, storage device 1208 may store one or more databases, including, for example, customer data 1212 (which may include customer behavior data and/or other historical customer data), possible payment card account data 1214 and/or historical data 1216 (which may include historical customer data).

Other programs and/or databases may also be employed. In some embodiments, program 310 may be configured as a neural-network or other type of program using techniques known to those skilled in the art to achieve the functionality described herein.

In some embodiments, system 202 may be operated by a financial institution that administers and/or underwrites payment card accounts.

In some embodiments, processing system 202 may be in communication with, or have access to, a number of types of market data and information (e.g., via communication device 1202).

In some embodiments, the processing system 202 may include but is not limited to: (1) modeling and/or analytical tools, for example, MODEL BUILDER software available from FAIR ISMC (or FICO), CHAID and CARD segmentation tools, (2) various types of processors and/or databases, for example, one or more processors provided by FIRST DATA RESOURCES (FDR), and/or (3) deployment and/or implementation tools, for example, TRIAD provided by FAIR ISMC and STRATEGY MANAGER. In some embodiments, the processing system 202 may include and/or receive data from various sources, which may include but is not limited to, data from a financial institution, (2) data from ACXIOM and/or (3) data from a credit bureau, e.g., EQUIFAX.

In some embodiments, one or more of the modeling and/or analytical tools, one or more of the deployment and/or implementation tools and/or one or more optimization tools (e.g., optimization software) may be integrated into a single platform. As stated above, examples of standard optimization software may include but are not limited to SOLVER provided by SAS, MARKETSWITCH provided by EXPERIAN and DECISION OPTIMIZER provided by FAIR ISMC.

As used herein, a processing system may be any type of processing system and a processor may be any type of processor. For example, a processing system may be programmable or non programmable, digital or analog, general purpose or special purpose, dedicated or non dedicated, distributed or non distributed, shared or not shared, and/or any combination thereof. A processing system employ continuous signals, periodically sampled signals, and/or any combination thereof. If the processing system has two or more distributed portions, the two or more portions may communicate with one another through a communication link. A processor system may include, for example, but is not limited to, hardware, software, firmware, hardwired circuits and/or any combination thereof.

Thus, in some embodiments, a processing system may include any sort or implementation of software, program, sets of instructions, code, ASIC, or specially designed chips, logic gates, or other hardware structured to directly effect or implement such software, programs, sets of instructions or code. The software, program, sets of instructions or code can be storable, writeable, or savable on any computer usable or readable media or other program storage device or media such as, for example, floppy or other magnetic or optical disk, magnetic or optical tape, CD-ROM, DVD, punch cards, paper tape, hard disk drive, Zip™ disk, flash or optical memory card, microprocessor, solid state memory device, RAM, EPROM, or ROM.

As used herein, a communication link may be any type of communication link, for example, but not limited to, wired (e.g., conductors, fiber optic cables) or wireless (e.g., acoustic links, electromagnetic links or any combination thereof including, for example, but not limited to microwave links, satellite links, infrared links), and/or combinations thereof, each of which may be public or private, dedicated and/or shared (e.g., a network). A communication link may or may not be a permanent communication link. A communication link may support any type of information in any form, for example, but not limited to, analog and/or digital (e.g., a sequence of binary values, i.e. a bit string) signal(s) in serial and/or in parallel form. The information may or may not be divided into blocks. If divided into blocks, the amount of information in a block may be predetermined or determined dynamically, and/or may be fixed (e.g., uniform) or variable. A communication link may employ a protocol or combination of protocols including, for example, but not limited to the Internet Protocol.

Unless otherwise stated, terms such as, for example, “in response to” and “based on” mean “in response at least to” and “based at least on”, respectively, so as not to preclude being responsive to and/or based on, more than one thing.

In addition, unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

While various embodiments have been described, such description should not be interpreted in a limiting sense. It is to be understood that modifications of such embodiments, as well as additional embodiments, may be utilized without departing from the spirit and scope of the invention, as recited in the claims appended hereto. It is therefore contemplated that the appended claims will cover any such modifications or embodiments as fall within the true scope of the invention.

What is claimed is:

1. A method comprising:
receiving data indicative of one or more characteristics of a customer having an existing or prospective relationship with a retail business;
providing data indicative of a plurality of possible payment card accounts that are available from a financial institution for customers of the retail business, each of the plurality of possible payment card accounts having at least one characteristic;
determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and
selecting one of the plurality of possible payment card accounts based at least in part on the estimate associated with the possible payment card account and on selection criteria that includes at least one criteria related to a financial metric of the retail business.

2. The method of claim 1 wherein each of the plurality of estimates comprises an estimate indicative of sales that would be realized by the retail business if the customer had a payment card account having the at least one characteristic of the associated one of the plurality of possible payment card accounts.

3. The method of claim 2 wherein selecting one of the plurality of possible payment card accounts comprises:
identifying one of the plurality of estimates of sales that has a greatest magnitude;
selecting a possible payment card account associated with the estimate that has the greatest magnitude.

4. The method of claim 1 further comprising offering a payment card account to the customer, the payment card account having the at least one characteristic of the selected one of the plurality of possible payment card accounts.

5. The method of claim 1 further comprising establishing a payment card account for the customer, the payment card account having the at least one characteristic of the selected one of the plurality of possible payment card accounts.

6. The method of claim 1 further comprising changing a payment card account of the customer to have the at least one characteristic of the selected one of the plurality of possible payment card accounts.

7. The method of claim 1 further comprising:
providing data indicative of a plurality of types of communication;
selecting at least one of the plurality of types of communication;
informing the customer of the selected one of the plurality of possible payment card accounts using the at least one selected type of communication.

8. The method of claim 1 wherein at least one of the plurality of possible payment card accounts comprises a possible private label credit card account, a possible dual card account or a possible co-brand credit card account.

9. The method of claim 1 wherein the at least one characteristic of the selected one of the plurality of possible payment card accounts comprises:
a credit limit; and
an interest rate.

10. The method of claim 1 wherein determining a plurality of estimates comprises:
providing at least one model based at least in part on historical data for a plurality of accounts of a plurality of customers; and
determining the plurality of estimates using the at least one model.

11. The method of claim 1 wherein determining a plurality of estimates comprises:
classifying the customer based at least in part on criteria defining a plurality of classifications;
providing a plurality of models, each associated with a respective one of the plurality of classifications; and
and determining the plurality of estimates using a model of the plurality of models that is associated with the classification of the customer.

12. The method of claim 1 further comprising determining a plurality of estimates, each of the plurality of estimates being associated with a respective one of the plurality of possible payment card accounts and indicative of a financial metric that would be realized by the financial institution if the customer had a payment card account having the at least one characteristic of the associated one of the plurality of possible payment card accounts.

13. The method of claim 12 wherein each of the plurality of estimates indicative of a financial metric that would be realized by the financial institution if the customer had a payment card account having the at least one characteristic of the associated one of the plurality of possible payment card accounts comprises:
an estimate indicative of profit that would be realized by the financial institution if the customer had a payment card account having the at least one characteristic of the associated one of the plurality of possible payment card accounts.

14. The method of claim 13 wherein selecting one of the plurality of possible payment card accounts comprises not selecting a possible payment card account associated with an estimate of profit that has a greatest magnitude among the plurality of estimates of profit.

15. The method of claim 13 wherein selecting one of the plurality of possible payment card accounts comprises selecting a possible payment card account associated with an estimate of profit that has a magnitude less than or equal to zero.

16. The method of claim 12 wherein each of the plurality of estimates indicative of a financial metric that would be realized by the financial institution if the customer had a payment card account having the at least one characteristic of the associated one of the plurality of possible payment card accounts comprises:
an estimate indicative of loss that would be realized by the financial institution if the customer had a payment card account having the at least one characteristic of the associated one of the plurality of possible payment card accounts.

17. The method of claim 16 wherein selecting one of the plurality of possible payment card accounts comprises not selecting a possible payment card account associated with an estimate of loss that has a smallest magnitude among the plurality of estimates of loss.

18. The method of claim 16 wherein selecting one of the plurality of possible payment card accounts comprises selecting a possible payment card account associated with an estimate of loss that has a magnitude greater than zero.

19. An apparatus comprising:
a processing system to (1) receive data indicative of one or more characteristics of a customer having an existing or prospective relationship with a retail business, (2) provide data indicative of a plurality of possible payment card accounts that are available from a financial institution for customers of the retail business, each of the plurality of possible payment card accounts having at least one characteristic, (3) determine a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts, and (4) select one of the plurality of possible payment card accounts based at least in part on the estimate associated with the possible payment card account and on selection criteria that includes at least one criteria related to a financial metric of the retail business.

20. Apparatus comprising:
means for receiving data indicative of one or more characteristics of a customer having an existing or prospective relationship with a retail business;
means for providing data indicative of a plurality of possible payment card accounts that are available from a financial institution for customers of the retail business, each of the plurality of possible payment card accounts having at least one characteristic;
means for determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and
means for selecting one of the plurality of possible payment card accounts based at least in part on the estimate associated with the possible payment card account and on selection criteria that includes at least one criteria related to a financial metric of the retail business.

21. A computer program product comprising:
a storage medium having stored thereon instructions that if executed by a machine, result in the following:
receiving data indicative of one or more characteristics of a customer having an existing or prospective relationship with a retail business;
providing data indicative of a plurality of possible payment card accounts that are available from a financial institution for customers of the retail business, each of the plurality of possible payment card accounts having at least one characteristic;
determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and
selecting one of the plurality of possible payment card accounts based at least in part on the estimate associated with the possible payment card account and on selection criteria that includes at least one criteria related to a financial metric of the retail business.

22. A storage medium having stored thereon instructions that if executed by a machine, result in the following:
receiving data indicative of one or more characteristics of a customer having an existing or prospective relationship with a retail business;
providing data indicative of a plurality of possible payment card accounts that are available from a financial institution for customers of the retail business, each of the plurality of possible payment card accounts having at least one characteristic;
determining a plurality of estimates, each of the plurality of estimates being associated with a respective one of the plurality of possible payment card accounts and indicative of a financial metric that would be realized by the retail business if the customer had a payment card account having the at least one characteristic of the associated one of the plurality of possible payment card accounts; and
selecting one of the plurality of possible payment card accounts based at least in part on the estimate associated with the possible payment card account and on selection criteria that includes at least one criteria related to a financial metric of the retail business.
